(19) United States
(12) Patent Application Publication
(10) Pub. No.: US 2008/0129740 A1
(43) Pub. Date: Jun. 5, 2008

(54) IMAGE PROCESSING APPARATUS, STORAGE MEDIUM THAT STORES IMAGE PROCESSING PROGRAM, AND IMAGE PROCESSING METHOD

(75) Inventors: Kazuyuki ITAGAKI, Tokyo (JP); Yusuke SUGIMOTO, Tokyo (JP); Takashi IGARASHI, Tokyo (JP); Takashi NAGAO, Kanagawa (JP); Yukio KUMAZAWA, Kanagawa (JP); Youichi ISAKA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/947,452

(22) Filed: Nov. 29, 2007

(30) Foreign Application Priority Data
Nov. 30, 2006 (JP) 2006-324685

(51) Int. Cl. G06F 15/16

(52) U.S. Cl. 345/502

(57) ABSTRACT

In an image processing apparatus, plural computational units execute computation relating to image processing. Plural image processing units cause the computational units to execute image processing on image information. A section number acquisition unit acquires a number of sections for sectioning the plural image processing units into groups. A sectioning unit sections the plural image processing units by causing the image processing units to belong to the respective groups based on the number of sections and the order of the image processing. A sequential storage processing unit receives requests for storage of the image information from image processing units belonging to the same group, and sequentially executes processing of the requests without performing exclusive access control. An exclusive access storage processing unit receives requests for storage of the image information from image processing units belonging to different groups, and executes processing of the requests while performing exclusive access control.

### CROSS-REFERENCE TO RELATED APPLICATION

This application claims priority under 35 USC 119 from Japanese Patent Application No. 2006-324685, the disclosure of which is incorporated by reference herein.

### BACKGROUND OF THE INVENTION

1. Field of the Invention

The present invention relates to an image processing apparatus, a storage medium that stores an image processing program, and an image processing method.

2. Description of the Related Art

The following approach has been suggested in which a desired processing procedure is assembled by combining plural image processing modules to perform image processing. As disclosed in Japanese Patent Application Publication (JP-B) No. 3617851, an approach has been suggested in which image processing modules are directly connected and each of the modules calls a preceding image processing module thereof for processing. An approach has been suggested in which a buffer that temporarily holds image data (image information) is arranged between the respective image processing modules, and if enough data to respond to an output request is not accumulated in the buffer, the preceding image processing module is caused to perform the processing, thereby linking together all the processing.

In order to achieve high-speed processing of the above-described approach of combining the plural image processing modules, speeding-up by parallel processing has also been suggested. As a parallelization approach corresponding to JP-B No. 3617851, there are techniques disclosed in Japanese Patent Application Laid-Open (JP-A) No. 10-304184, and the like.

Moreover, in approaches to combining and processing plural image processing modules, a technique of increasing processing speed by assigning plural threads for parallelization has been suggested. However, extra cost for exclusive access control (not involved in sequential processing) occurs in the parallel processing. Moreover, an apparatus has an inherent number of threads or a number of threads that can validly operate at a given point of time, and thus, when A modules are processed in parallel, it is not necessarily desirable that the processing be simply performed with A threads.

For example, when A modules are assigned to A threads, and the number of valid computational resources of the apparatus is N (A>N), an OS (Operating System) performs the scheduling. However, extra switching-over of the threads occurs, thereby resulting in a decrease in efficiency. Furthermore, since the threads are allocated to a given computational resource randomly, the computational resources are not used uniformly. As a result, far more processing cost than (total processing cost/computational resources) may be required. The above-described JP-A No. 10-304184 and the like may not address this problem.

In order to avoid the decrease in parallelization efficiency due to the assignment nonuniformity, various devices have been conceived.

For example, in JP-A No. 2005-250565, the following method is suggested. A load is estimated from the latest execution result, and based on this estimated load processing modules are divided into two groups of heavy load and light load. Unit processing of the modules of heavy loads is first assigned and after completing this assignment, unit processing of the modules of light loads is assigned in the order of from the thread of the lightest estimated load. This reduces the nonuniformity in the assignment.

Moreover, in JP-A No. 2005-259042, the processes are grouped based on difference in the processing method thereof. When an empty thread occurs, a processes is not selected of the same group as that of the process being executed in other thread(s). Thereby, an assignment method for avoiding competition for the resources is suggested.

Furthermore, in JP-A No. 2006-4382, it has been suggested that in cases where processing is shared between, and carried out in, plural apparatuses, the share ratio of an apparatus having a longer processing time is decreased based on the history of the processing share ratio and the share time of each of the apparatuses.

However, the methods disclosed in JP-A No. 2005-250565 and JP-A No. 2005-259042 require some exclusive access control between the respective modules since the assignment is performed without considering the order of the processing modules or the like. When only a few computational resources are present, and the number of valid threads is smaller than the number of the modules, unnecessary exclusive access control intervenes.

Moreover, the method disclosed in JP-A No. 2006-4382 may be applied when the processing units and their order are fixed, but it may not be applied when the processing units and their order differ.

There is a problem with conventional technology in that efficient parallel processing is not executed.

### SUMMARY OF THE INVENTION

The present invention has been made in view of the above circumstances and provides an image processing apparatus, a storage medium for storing an image processing program, and an image processing method.

According to an aspect of the invention, there is provided an image processing apparatus comprising: a plurality of computational units that execute computation related to image processing; a plurality of image processing units that cause the computational units to execute image processing on image information; a section number acquisition unit that acquires a number of sections for sectioning the plurality of image processing units into a plurality of groups; a sectioning unit that sections the plurality of image processing units by causing the respective image processing units to belong to the respective groups based on the number of sections acquired by the section number acquisition unit and the order of the image processing that the image processing units cause the computational units to execute; a sequential storage processing unit that receives requests for storage of the image information from image processing units belonging to the same group, and sequentially executes processing of the requests from the image processing units without performing exclusive access control; and an exclusive access storage processing unit that receives requests for storage of the image information from image processing units belonging to different groups, and executes processing of the requests from the image processing units while performing exclusive access control.

### BRIEF DESCRIPTION OF THE DRAWINGS

Preferred exemplary embodiments of the present invention will be described in detail based on the following figures, wherein:

FIG. 1 is a block diagram showing a schematic configuration of a computer (image processing apparatus) according to an exemplary embodiment.

FIGS. 2A to 2C are block diagrams showing configuration examples of an image processor.

FIGS. 3A, 3B are block diagrams showing schematic configurations of an image processing module and a buffer module, and executed processing thereof, respectively.

FIG. 4 is a sequence diagram for explaining a series of processing from the construction of the image processor to the execution of the image processing.

FIGS. 5A to 5C are schematic diagrams for explaining a case where image data to be written lies across plural unit buffer region for storage.

FIGS. 6A to 6C are schematic diagrams for explaining a case where image data to be read lies across plural unit buffer regions for storage.

FIG. 7 is a flowchart showing the contents of image processing module control processing executed by a controller of an image processing module.

FIGS. 8A to 8D are flowcharts showing the contents of block unit control processing executed by a work flow manager of a processing manager.

FIG. 9 is a schematic diagram for explaining a flow of the image processing in the image processor.

FIG. 10 is a diagram showing a detailed configuration of the processing manager.

FIG. 11 is a diagram showing one example of a module table.

FIG. 12 is a diagram showing examples of graphs for finding a processing cost.

FIG. 13 is a diagram showing a thread configuration example in which four modules are sectioned into four groups.

FIG. 14 is a diagram showing a thread configuration example in which four modules are sectioned into two groups.

FIG. 15 is a flowchart showing fundamental processing of sectioning the plural image processing modules into the groups.

FIG. 16 is a flowchart showing section number acquisition processing (No. 1).

FIG. 17 is a diagram showing a sectioning example (No. 1).

FIG. 18 is a flowchart showing the section number acquisition processing (No. 2).

FIG. 19 is a flowchart showing sectioning processing (No. 1).

FIG. 20 is a flowchart showing the sectioning processing (No. 2).

FIG. 21 is a diagram showing a sectioning example (No. 2).

FIG. 22 is a flowchart showing the sectioning processing (No. 3).

FIG. 23 is a diagram showing a sectioning example (No. 3).

FIG. 24 is a diagram showing a sectioning example (No. 4).

FIG. 25 is a diagram showing a sectioning example (No. 5).

### DETAILED DESCRIPTION OF THE INVENTION

Hereinafter, an exemplary embodiment of the present invention is described with reference to the drawings.

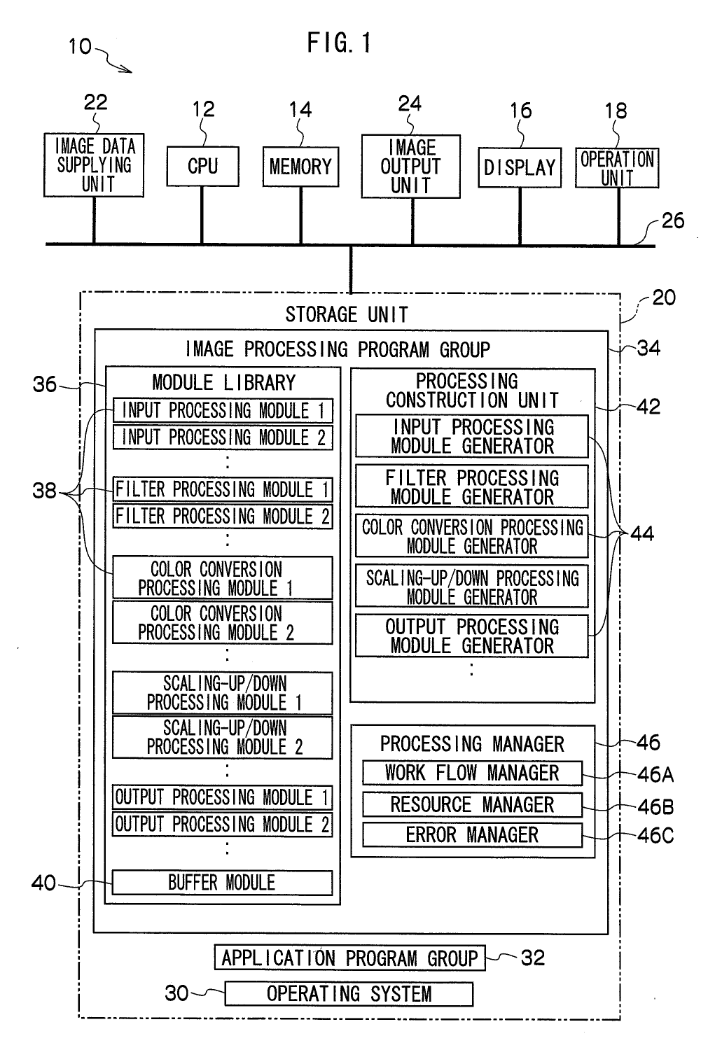

In FIG. 1, a computer 10 capable of functioning as an image processing apparatus according to the invention is shown. This computer 10 may be incorporated in arbitrary image treating equipment that requires image processing to be performed internally, such as a copier, printer, facsimile apparatus, complex machine including these functions in combination, scanner, and photo-printer. The computer 10 may be an independent computer such as a personal computer (PC). The computer 10 may be a computer incorporated in portable equipment such as a PDA (Personal Digital Assistant) and portable telephone.

The computer 10 includes a CPU 12, a memory 14, a display 16, an operation unit 18, a storage unit 20, an image data supplying unit 22, and an image output unit 24, which are mutually connected through a bus 26. In the case where the computer 10 is incorporated in the image treating equipment as described above, as the display 16, and the operation unit 18, a display panel made of LCD or the like, numeric keypad and the like, which are provided in the image treating equipment, may be applied. In the case where the computer 10 is an independent computer, a display, keyboard, mouse and the like, which are connected to the relevant computer, may be applied as the display 16 and the operation unit 18. Moreover, as the storage unit 20, while HDD (Hard Disk Drive) is preferable, alternately, another nonvolatile storage means such as a flash memory may be used.

Moreover, as the image data supplying unit 22, any type capable of supplying image data to be processed may be employed. To the image data supplying unit 22, an image reader that reads an image recorded on a recording material such as paper and photographic film and outputs the image data, a receiver that receives image data externally through a communication line, an image storage unit that stores image data (the memory 14 or the storage unit 20) and the like may be applied.

Moreover, as the image output unit 24, any type that outputs image data subjected to the image processing or an image represented by the image data may be employed. To the image output unit 24, an image recorder that records an image represented by image data on a recording material such as paper and sensitive material, for example, a display that displays an image represented by image data thereon or the like, a writing device that writes image data on a recording medium, and a transmitter that transmits image data through a communication line may be applied. Moreover, the image output unit 24 may be an image storage unit that merely stores image data subjected to the image processing (the memory 14 or the storage unit 20).

As shown in FIG. 1, the storage unit 20 stores a program of an operating system 30, an image processing program group 34, and programs of various applications 32 (denoted by an application program group 32 in FIG. 1), respectively, as various programs executed by the CPU 12. The program of the operating system 30 is responsible for the management of resources of the memory 14 and the like, the management of execution of the programs by the CPU 12, the communication between the computer 10 and the outside, and the like. The image processing program group 34 causes the computer 10 to function as the image processing apparatus according to the invention. The programs of the applications 32 cause the image processing apparatus realized by the CPU 12 executing the image processing program group to perform desired image processing.

The image processing program group 34 consists of programs developed so as to be usable in common to the various types of image treating equipment and portable equipment, and various devices (platforms) of a PC or the like for the purpose of reducing development load in developing the various types of image treating equipment and portable equipment, and reducing development load in developing the image processing program usable in PC or the like. The image processing program group 34 corresponds to an image processing program according to the invention.

The image processing apparatus realized by the image processing program group 34 constructs an image processor that performs image processing instructed by the application 32 in accordance with a construction instruction from the application 32. The image processing apparatus performs the image processing by the above-mentioned image processor in accordance with an execution instruction from the application 32 (details will be described later). The image processing program group 34 instructs the construction of an image processor performing desired image processing (image processor of a desired configuration). Moreover, the image processing program group 34 provides the application 32 with an interface for instructing the execution of the image processing by the constructed image processor.

Thus, even when newly developing arbitrary equipment requiring image processing to be performed internally and so on, for the development of the program performing the image processing, it is only needed to develop the application 32 that causes the image processing program group 34 to perform the image processing required in the relevant equipment by utilizing the above-described interface. Since the program performing the image processing does not need to be actually developed, the development load may be reduced.

Moreover, the image processing apparatus realized by the image processing program group 34 constructs the image processor that performs the image processing instructed by the application 32 in accordance with the construction instruction from the application 32, and causes the constructed image processor to perform the image processing, as described before. Thus, even if, for example, color spaces of image data to be subjected to the image processing or the number of bits per pixel are indefinite, or the contents, a procedure/parameter and the like of the image processing to be executed are indefinite, by the application 32 instructing reconstruction of the image processor, the image processing to be executed by the image processing apparatus (image processor) may be changed flexibly in accordance with the image data to be processed or the like.

Hereinafter, the image processing program group 34 is described.

As shown in FIG. 1, the image processing program group 34 is roughly divided into a module library 36 and programs of a processing construction unit 42, and a processing manager 46.

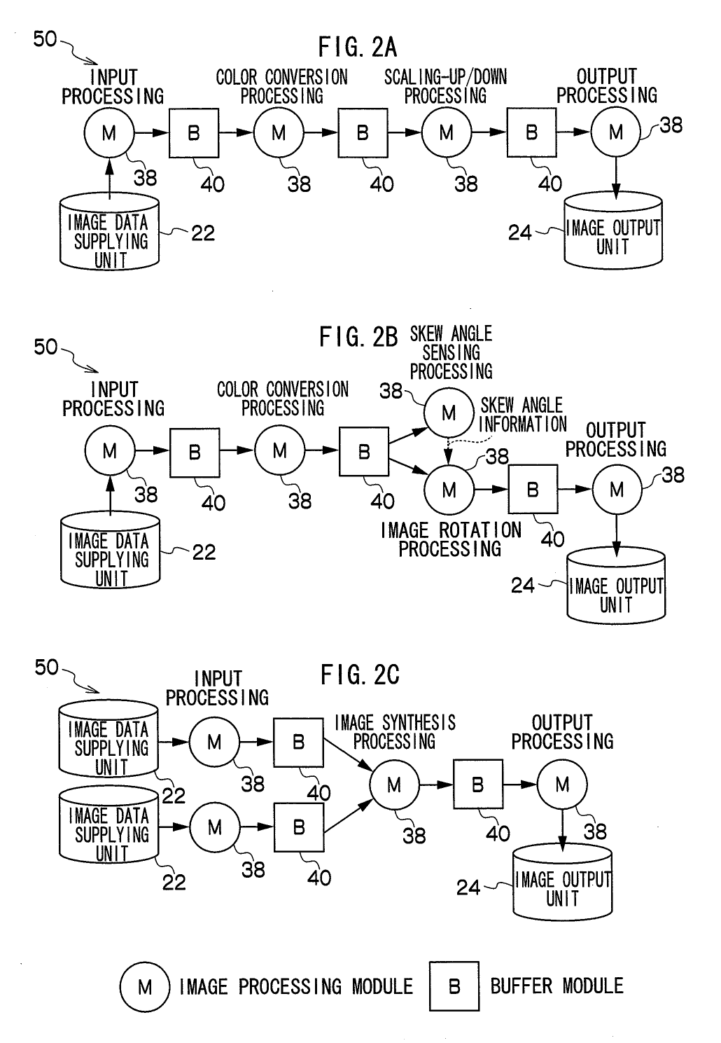

As shown as examples in FIGS. 2A to 2C, the processing construction unit 42 according to the exemplary embodiment constructs an image processor 50 configured by connecting one or more image processing modules 38 and buffer modules 40 in a pipe line form or in a DAG (Directed Acyclic Graph) by an instruction of the application. Each of the image processing modules 38 performs predetermined image processing. Each of the buffer modules 40 is arranged at least one of preceding stage and following stage of the individual image processing module 38 and has a buffer for storing image data.

An entity of the individual image processing module making up the image processor 50 is a first program executed by the CPU 12 and intended for causing the predetermined image processing to be performed in the CPU 12, or a second program executed by the CPU 12 and intended to cause the CPU 12 to instruct the execution of the processing to an external image processing apparatus (e.g., dedicated image processing board or the like) not shown in FIG. 1. In the above-described module library 36, programs of plural types of image processing modules 38 that perform predetermined image processing different from each other (e.g., input processing and filter processing, color conversion processing, scaling-up/down processing, skew angle sensing processing, image rotation processing, image synthesis processing, output processing and the like) are registered, respectively. Hereinafter, for simplicity of description, a description is given on the assumption that the entity of the individual image processing module making up the image processor 50 is the above-mentioned first program.

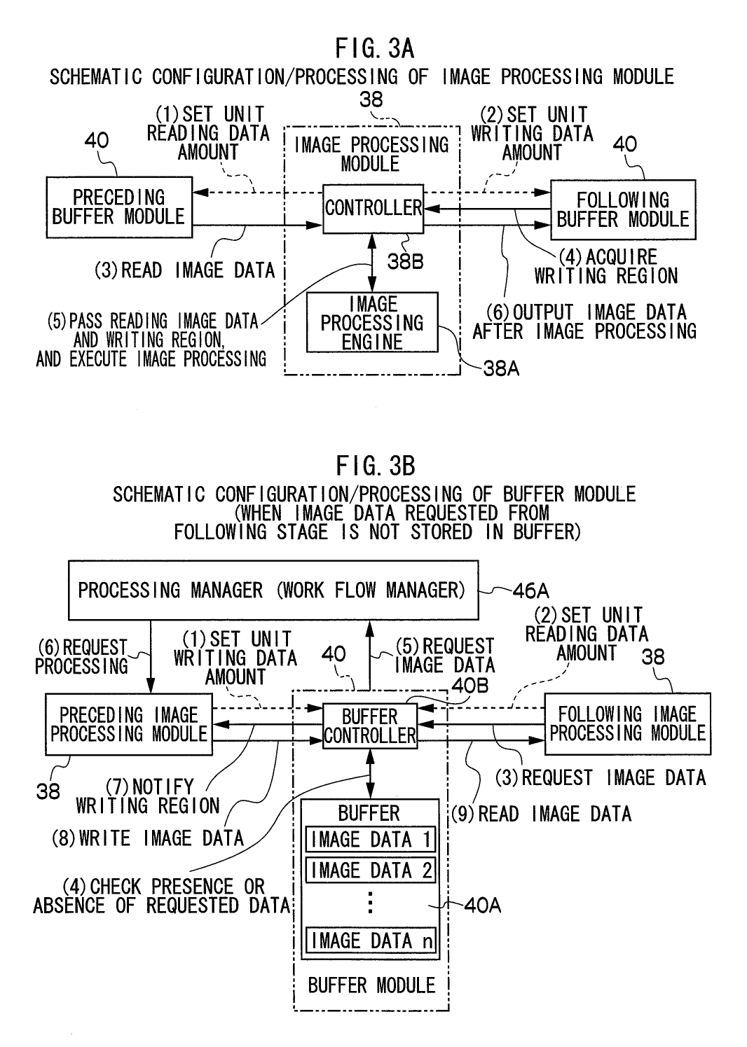

The individual image processing module 38 is made of an image processing engine 38A and a controller 38B, as shown as an example in FIG. 3A. The image processing engine 38A performs the image processing to the image data on a basis of a predetermined unit processing data amount. The controller 38B controls the input and output of the image data to and from a preceding module and a following module of the image processing module 38, and the image processing engine 38A.

The unit processing data amount in the individual image processing module 38 is selected/set in advance from arbitrary numbers of bits equivalent to one line of the image, plural lines of the image, one pixel of the image, one surface of the image and the like in accordance with the type of the image processing performed by the image processing engine 38A or the like. For example, in the image processing module 38 performing color conversion processing and filter processing, the unit processing data amount is set to one pixel. In the image processing module 38 performing scaling-up/down processing, the unit processing data amount is set to one line of the image or plural lines of the image. In the image processing module 38 performing image rotation processing, the unit processing data amount is set to one surface of the image. In the image processing module 38 performing image compression and expansion processing, the unit processing data amount is set to N bytes depending on the execution environment.

Moreover, in the module library 36, the image processing modules 38 in which the type of image processing that the image processing engines 38A executes is the same, and the contents of the image processing to be executed are different are also registered (in FIG. 1, this type of image processing modules is denoted by as “module 1”, “module 2”).

For example, for the image processing module 38 performing the scaling-up/down processing, the plural image processing modules 38 such as an image processing module 38 performing the scaling-down processing that scales down to 50% by thinning out the inputted image data every other pixel, and an image processing modules 38 performing the scaling-up/down processing at a scaling-up/down ratio specified to the inputted image data are prepared. Moreover, for example, for the image processing module 38 performing the color conversion processing, the image processing modules 38 such as an image processing module 38 converting an RGB color space to a CMY color space, or converting reversely, and an image processing module 38 performing the color space conversion to another space conversion such as an L*a*b* color space are prepared.

Moreover, the controller 38B of the image processing module 38 acquires the image data on a basis of unit reading data amount from a preceding module of its own module (e.g., a buffer module 40) in order to input the image data needed for the image processing engine 38A to process on a basis of unit processing data amount. The controller 38B outputs the image data outputted from the image processing engine 38A to the following module (e.g., a buffer module 40) on a basis of unit writing data (if the image processing engine 38A does not perform the image processing involving increase or decrease in the data amount such as compression, the unit writing data amount is equal to the unit processing data amount), or performs the processing of outputting a result of the image processing by the image processing engine 38A outside of its own module, (e.g., in the case where the image processing engine 38A performs image analysis processing such as skew angle sensing processing, an image analysis processing result such as the skew angle sensing result may be outputted instead of the image data). In the module library 36, the image processing modules 38 in which the type and the contents of the image processing that the image processing engines 38A execute are the same, but the above-mentioned unit processing data amount, the unit reading data amount, and the unit writing data amount are different are also registered. For example, for the image processing module 38 performing the image rotation processing, in addition to a program of an image processing module 38 with the unit processing data amount set to one surface of an image, programs of image processing modules 38 with the unit processing data amounts set to one line of the image, and set to plural lines of the image may be registered in the module library 36, as described above.

Moreover, the program of the individual image processing module 38 registered in the module library 36 is made of a program corresponding to the image processing engine 38A and a program corresponding to the controller 38B. The program corresponding to the controller 38B is modularized. The image processing modules 38 whose unit reading data amount and the unit writing data amount are the same among the image processing modules 38 share the program corresponding to the controller 38B regardless of the type and the contents of the image processing executed by their image processing engines 38A (i.e., the same program is used as the program corresponding to the controller 38B). This reduces the development load in the development of the programs of the image processing modules 38.

Among the image processing modules 38, there are modules in which the unit reading data amount and the unit writing data amount are not established in a state where an inputted image attribute is unknown, and by acquiring the attribute of the inputted image data and assigning the acquired attribute to a predetermined arithmetic (computational) formula for computational operation to establish the unit reading data amount and the unit writing data amount. With regard to this type of image processing modules 38, the image processing modules 38 whose unit reading data amount and unit writing data amount are derived using the same arithmetic formulae from one another may share the program corresponding to the controller 38B.

Moreover, the image processing program group 34 according to the exemplary embodiment may be implemented in various types of equipment as described above. The number, types and the like of the image processing modules 38 registered in the module library 36 in the image processing program group 34 may be added, deleted, replaced and the like as needed in accordance with the image processing needed in the various types of equipment implementing the image processing program group 34.

Moreover, the individual buffer module 40 making up the image processor 50 is made of a buffer 40A and a buffer controller 40B as shown as an example in FIG. 3B. The buffer 40A is made of a memory region allocated in the memory 14 provided in the computer 10 through the operating system 30. The buffer controller 40B performs the input and output of image data to and from a preceding module and a following module of the relevant buffer module 40 and the management of the buffer 40A. An entity of the buffer controller 40B of the individual buffer module 40 is also a program executed by the CPU 12. In the module library 36, the program of the buffer controller 40B is also registered (in FIG. 1, the program of the buffer controller 40B is denoted by “buffer module”).

Moreover, the processing construction unit 42 that constructs the image processor 50 in accordance with an instruction from the application 32 is made of plural types of module generators 44 as shown in FIG. 1. The plural types of module generators 44 correspond to image processing different from one another. The module generators 44 are each activated by the application 32 to thereby perform the processing of generating a module group consisting of the image processing modules 38 and the buffer modules 40.

In FIG. 1, as examples of the module generators 44, the module generators 44 corresponding to the types of the image processing that the individual image processing modules 38, which are registered in the module library 36, execute are shown. However, the image processing corresponding to the individual module generator 44 may be image processing realized by the plural types of image processing modules 38 (e.g., skew correction processing consisting of the skew angle sensing processing and the image rotation processing). In the case where the needed image processing is processing combined by plural types of image processing, the application 32 sequentially activates the module generators 44 corresponding to any one of the plural types of image processing. This allows the module generators 44 activated sequentially by the application 32 to construct the image processor 50 that performs the needed image processing.

Moreover, as shown in FIG. 1, the processing manager 46 includes a work flow manager 46A, a resource manager 46B, and an error manager 46C. The work flow manager 46A controls the execution of the image processing in the image processor 50. The resource manager 46B manages the use of the resources of the computer 10 such as the memory 14 and various files by the respective modules of the image processor 50. The error manager 46C manages an error that occurs in the image processor 50.

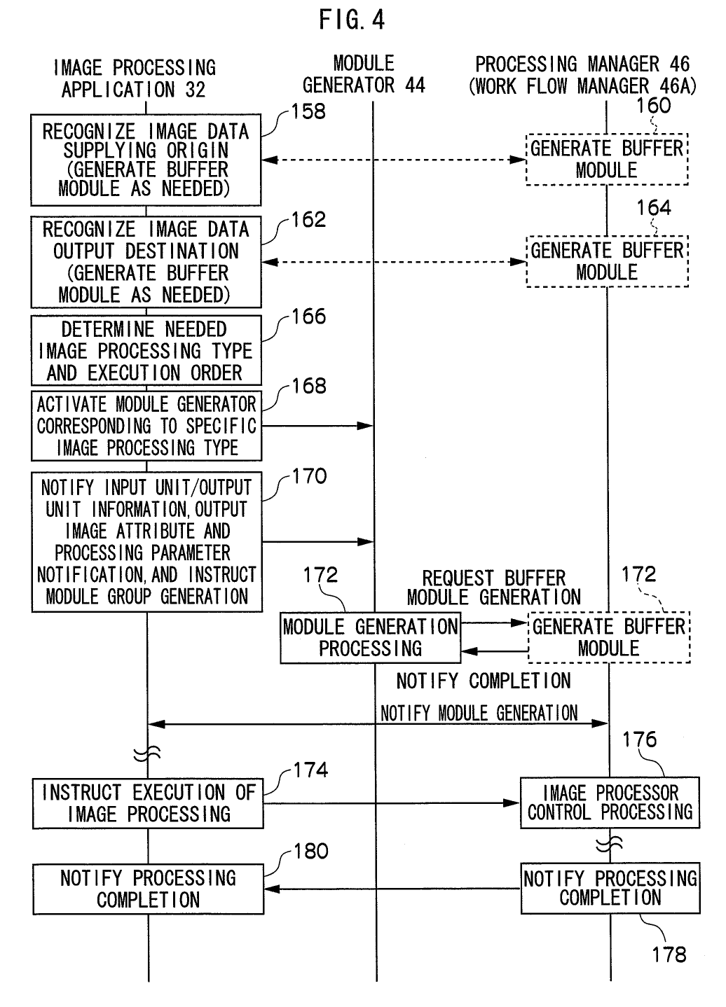

Next, operation of the exemplary embodiment is described with reference to a sequence diagram of FIG. 4.

When the equipment with the image processing program group 34 implemented comes to a situation where some image processing needs to be performed, this situation is sensed by the specific application 32.

As the situation where the image processing needs to be performed, for example, there is a case where a user instructs the execution of a job of reading an image by an image reader as the image data supplying unit 22 to record the image on a recording material by an image recorder as the image output unit 24, to cause the image to be displayed on the display as the image output unit 24, to write the image data on a recording medium by a writing device as the image output unit 24, to transmit the image data by a transmitter as the image output unit 24 or to store the image data on the image storage unit as the image output unit 24. Alternatively, there is a case where a user instructs the execution of a job of performing any one of recording on the above-described recording material, displaying on the display, writing on the recording medium, transmitting, and storing in the image storage unit with respect to image data received by a receiver as the image data supplying unit 22, or stored in the image storage unit as the image data supplying unit 22.

Moreover, the situation where the image processing needs to be performed is not limited to the foregoing. For example, there may be a case where a user selects processing to be executed in a state where titles of processing executable by the applications 32 and the like are displayed by a list on the display 16 in accordance with the instruction from the user.

First, the application 32 recognizes the type of the image data supplying unit 22 that supplies image data to be subjected to the image processing in step 158. If the recognized type is a buffer region (a partial region of the memory 14), the application 32 notifies the buffer region specified as the image data supplying unit 22 to the active processing manager 46 to request the generation of a buffer module 40 functioning as the image data supplying unit 22 to the processing manager 46. In this case, in step 160, the processing manager 46 loads the program of the buffer controller 40B in the memory 14 so that the CPU 12 may execute it. The processing manager 46 sets a parameter for causing the buffer controller 40B to recognize the notified buffer region (buffer region specified as the image data supplying unit 22) as the buffer 40A that has already been allocated. In this manner, the processing manager 46 generates the buffer module 40 functioning as the image data supplying unit 22 and returns a response to the application 32.

Subsequently, in step 162, the application 32 recognizes the type of the image output unit 24 as an output destination of the image data subjected to the image processing. Moreover, if the recognized type is a buffer region (partial region of the memory 14), the application 32 notifies the buffer region specified as the image output unit 24 to the active processing manager 46 to cause the processing manager 46 to generate the buffer module 40 including the buffer region specified as the image output unit 24 (buffer module 40 functioning as the image output unit 24). In this case, as in the foregoing, the processing manager 46 generates the buffer module and returns a response to the application 32 in step 164.

Next, the application 32 recognizes the contents of the image processing to be executed in step 166. The application 32 breaks the image processing to be executed into combination of image processing of levels corresponding to the individual module generators 44. The application 32 determines the types of image processing and execution order of the respective image processing necessary for realizing the image processing to be executed. This determination is registered in advance as information in such a manner as to associate the above-described types of the image processing and the execution order of the respective image processing with the type of a job the execution of which the user may instruct. The application 32 may be realized by reading the information corresponding to the type of the job the execution of which is instructed. Details of this determination as to the execution order of the image processing in step 166 will be described later.

In step 168, the application 32 activates the module generators 44 corresponding to the specific image processing based on the types and the execution order of the image processing determined above.

Furthermore, in step 170, the application 32 notifies each of the activated module generators 44 of input module identification information, output module identification information, input image attribute information, and a parameter of the image processing to be executed as the information necessary for the generation of the module group by the relevant module generator 44, and instructs the generation of the corresponding module group. The input module identification information identifies an input module inputting the image data to the above-mentioned module group. The output module identification information identifies an output module to which the above-mentioned module group outputs the image data. The input image attribute information indicates an attribute of the input image data inputted to the above-mentioned module group.

Moreover, in the case where the needed image processing is processing in combination of plural types of image processing, upon receiving a notification of completing the generation of the module group from the instructed module generator 44, the application 32 repeats the processing of activating another module generator 44 corresponding to the individual image procession and notifying the necessary information for generating the module group (steps 168, 170) in ascending execution order of the respective image processing.

With regard to the input module, in the first module group in the execution order, the image data supplying unit 22 is the input module. As for the second module group or later in the execution order, the final module of the preceding module group (normally, the buffer module 40) is the input module. Moreover, with regard to the output module, in the last module group in the execution order, the image output unit 24 is the output module. Thus, the image output unit 24 is specified as the output module. In the other module group, since the output module is not decided, the specification by the application 32 is not performed, but an output module is generated or set by the module generator 44 if necessary. Moreover, for example, the input image attribute and the parameter of the image processing are registered in advance as information in association with the type of job the execution of which the user may instruct. By reading the information corresponding to the type of the job, the execution of which is instructed may allow the application 32 to recognize them. Also, the user may specify the parameter.

On the other hand, in step 172, upon being activated by the application 32, the module generator 44 performs module generation processing. In the module generation processing, the input image attribute information indicating an attribute of the input image data inputted to the image processing module 38 to be generated is first acquired. The processing of acquiring the attribute of the input image data may be realized by acquiring the attribute of the output image data from the preceding image processing module 38 that writes the image data in a relevant buffer module 40 in the case where the relevant buffer module 40 exists at the preceding stage of the image processing module 38 to be generated.

Based on the attribute of the input image data indicated by the acquired information, it is determined whether or not the generation of the image processing module 38 to be generated is necessary. For example, in the case where the module generator 44 is a module generator generating a module group performing color conversion processing, and a CMY color space is specified by the application 32 as a color space of the output image data in accordance with the parameter of the image processing, if it is determined that the input image is data of a RGB color space based on the acquired input image attribute information, then the image processing module 38 performing the color space conversion from RGB to CMY needs to be generated as the image processing module 38 performing the color space processing. If the input image data is data of the CMY color space, the attributes of the input image data and the output image data coincide with each other in color space, so that it is determined that the image processing module 38 performing the color space conversion processing need not be generated.

If it is determined that the generation of the image processing module 38 to be generated is necessary, whether or not the buffer module 40 is necessary at the following stage of the image processing module 38 to be generated is necessary. In the case where the following stage of the image processing module is the output module (image output unit 24) (e.g., refer to the final image processing module 38 in each of the image processors 50 shown in FIGS. 2A to 2C) or in the case where the image processing module is a module performing the image processing such as analysis to the image data to output the result to another image processing module 38 as in the image processing module 38 performing the skew angle sensing processing in the image processor 50 as shown as an example in FIG. 2B, this determination is negative. In others than the foregoing cases, the determination is affirmative, so that the generation of the buffer module 40 connected at the following stage of the image processing module 38 is requested to the active processing manager 46.

Upon requesting the generation of the buffer module 40, in step 172, the processing manager 46 loads the program of the buffer controller 40B on the memory 14 so that the CPU 12 may execute it to thereby generate the buffer module 40 and returns a response to the module generator 44.

Subsequently, the module generator 44 provides the information of the preceding module (e.g., buffer module 40), the information of the following buffer module 40, and the attribute and the processing parameter of the input image data inputted to the image processing module 38 to generate the image processing module 38. The image processing module 38 for which it is determined that the following buffer module 40 is not necessary is not provided with the information of the following buffer module 40. In the case where the processing contents are fixed, such as 50% scaling-down processing, so that no special image parameter is not necessary, the processing parameter is not provided.

The module generator 44 selects the image processing module 38 matching the acquired attribute of the input image data and the processing parameter to be executed in the image processing module 38 from the plural candidate modules available as the image processing modules 38, which are registered in the module library 36, and loads the program of the selected image processing module 38 on the memory 14 so that the CPU 12 can execute it. Parameters are set for causing the controller 38B of the relevant image processing module 38 to recognize the preceding and following modules of the relevant image processing module 38 are set. In this manner, the image processing module 38 is generated.

For example, in the case where the module generator 44 is a module generator generating a module group performing the color conversion processing, and if the CMY color space is specified as a color space of the out put image data in accordance with the processing parameter and further the input image data is data of the RGB color space, the image processing module 38 performing the color space conversion from RGB to CMY is selected and generated from the plural types of the image processing modules 38 performing the various types of color space processing registered in the module library 36.

Moreover, in the case where the image processing module is the image processing module 38 performing the scaling-up/down processing, and if the specified scaling-up/down ration is other than 50%, the image processing module 38 performing the scaling-up/down processing at a specified scaling-up/down ratio to the inputted image data is selected and generated. If the specified scaling-up/down ratio is 50%, the image processing module 38 performing the scaling-up/down processing specializing in the scaling-up/down 50%, that is, the scaling-down processing of scaling down the inputted image data to 50% by thinning it out every other pixel is selected and generated.

The selection of the image processing module 38 is not limited to the foregoing. For example, plural image processing modules 38 each having a different unit processing data amount in the image processing by the image processing engine 38A may be registered in the module library 36, and the image processing module 38 having an appropriate unit processing data amount may be selected in accordance with the operating environment such as a size of the memory region that can be allocated to the image processor 50 (e.g., as the above-mentioned size becomes smaller, the image processing module 38 having a smaller unit processing data amount is selected, and so on). The application 32 or the user may select the image processing module 38.

Upon completing the generation of the image processing module 38, the module generator 44 notifies the active processing manager 46 of a pair of IDs of the following buffer module 40 and the generated image processing module 38. Each of these IDs may be information by which the individual module may be uniquely identified. For example, the ID may be a number given in a generation order of the respective modules or may be an address of an object of the buffer module 40 or the image processing module 38 on the memory, and so on.

Moreover, in the case where the module generator 44 generates a module group performing image processing realized by plural types of image processing modules 38 (e.g., skew correction processing realized by the image processing module 38 performing the skew angle sensing processing and the image processing module 38 performing the image rotation processing), the above-described processing is repeated to generate a module group including the two or more image processing modules 38. The above-described module generation processing is sequentially performed by the respective module generators 44 activated sequentially by the application 32. In this manner, as shown as examples in FIGS. 2A to 2C, the image processors 50 performing the needed image processing are constructed.

Meanwhile, when the above-described module generation processing is sequentially performed by the module generators 44 activated sequentially, and the construction of the image processor 50 performing the needed image processing is completed, the application 32 instructs the execution of the image processing by the image processor 50 to the active processing manager 46 in step 174.

Upon being given the instruction of the execution of the image processing from the application 32, in step 176, the processing manager 46 causes the CPU 12 to execute the program of each of the modules of the image processor 50, which is loaded on the memory 14, as a thread (or a process or an object) through the operating system 30.

When the program of the image processing module 38 is executed as a thread, the controller 38B of the individual image processing module 38 initializes its own module. In the initialization of the image processing module 38, the preceding module of its own module is determined based on the parameter set by the module generator 44. In the case where there exists no module at the preceding stage of its own module, no processing is performed. In the case where the preceding module is other than the buffer module 40, for example, the image data supplying unit 22, a specific file or the like, the initialization processing is performed as necessary. Moreover, in the case where the buffer module 40 exists at the preceding stage of its own module, a data amount of the image data acquired by one reading of the image data (unit reading data amount) from the preceding buffer module 40 is recognized.

This unit reading data amount is one if the number of the preceding buffer modules 40 of its own module is one. However, if the number of the preceding buffer modules 40 is plural, and using the image data acquired from the plural buffer modules 40 respectively, the image processing engine 38A performs the image processing as in the image processing module 38 performing the image synthesis processing in the image processor 50 shown in FIG. 2C, for example, the unit reading data amount corresponding to the individual preceding buffer module 40 is fixed in accordance with the type and the contents of the image processing that the image processing engine 38A of its own module performs, and the number of the preceding buffer modules 40 or the like. By notifying the recognized unit reading data amounts to all the buffer modules 40 existing at the preceding stage, the unit reading data amounts are set in all the buffer modules 40 existing at the preceding stage (refer to FIG. 3A (1) as well).

Next, the following module of its own module is determined. If the following module of its own module is other than a buffer module 40, for example, the image output unit 24, a specific file or the like, the initialization processing (e.g., if the following module is the image output unit 24, processing of notifying the output of the image data on a basis of data amount equivalent to the unit writing data amount, and so on) is performed as necessary. Moreover, if the following the module is the buffer module 40, an data amount of the image data in one writing of the image data (unit writing data amount) is recognized and the relevant unit writing data amount is set in the following buffer module (refer to FIG. 3A (2) as well). The completion of the initialization of the relevant image processing module 38 is notified to the processing manager 46.

When the program of the buffer module 40 (buffer controller 40B thereof) is executed as a thread, the buffer controller 40B of the individual buffer module 40 initializes its own module. In the initialization of the buffer module 40, every time a unit writing data amount is notified from the preceding image processing module 38 of the its own module, or a unit reading data amount is notified from the following image processing module 38 of its own module, the notified unit writing data amount or unit reading data amount is stored (refer to FIGS. 3B (1) and (2) as well).

When the unit writing data amounts or the unit reading data amounts are notified from all the image processing modules 38 connected to its own module, a size of a unit buffer region, which is a management unit of the buffer 40A of its own module, is determined based on the unit writing data amount and the unit reading data amount set by the individual image processing modules 38 connected to its own module respectively, and stores the determined size of the unit buffer region. As the size of the unit buffer region, a maximum value of the unit writing data amount and the unit reading data amount set in its own module is preferable. However, the unit writing data amount may be set. Alternatively, the unit reading data amount (if the plural image processing modules 38 are connected at the following stage of its own module, a maximum value of the unit reading data amounts set by the individual image processing modules 38 respectively) may be set. A least common multiple of the unit writing data amount and the unit reading data amount (its the maximum value) may be set. If this least common multiple is less than a predetermined value, the least common multiple may be set, and if the least common multiple is the predetermined value or more, another value (e.g., any one of the above-mentioned maximum value of the unit writing data amount and the unit reading data amount, the unit writing data amount, the unit reading data amount (maximum value thereof)) may be set.

Moreover, if its own module is the buffer module 40 functioning as the image data supplying unit 22 or the image output unit 24, a memory region used as the buffer 40A of its own module has already existed. The size of the unit buffer region determined previously is changed to the size of the existing memory region used as the buffer 40A of its own module. Furthermore, valid data pointers corresponding to the following individual image processing modules 38 of its own module are generated, respectively, and the generated valid data pointers are initialized. These valid data pointers are pointers indicating a head position (next reading starting position) and an end position of image data (valid data) that has not been read by the corresponding following image processing module 38 in image data written in the buffer 40A of its own module by the preceding image processing module of its own module, respectively. In these valid data pointers, specific information meaning that normally, no valid data exists is set at the initialization time. If its own module is the buffer module 40 functioning as the image data supplying unit 22, in the memory region used as the buffer 40A of its own module, the image data to be subjected to the image processing may have been written, and in this case, a head position and an end position of the relevant image data are set by the valid data pointers corresponding to the following individual image processing module 38, respectively. By the above-described processing, the initialization of the buffer module 40 is completed, and the buffer controller 40B notifies the completion of the initialization to the processing manager 46.

Upon being notified of the completion of initialization from all the modules making up the image processor 50, the processing manager 46 activates a thread (or a process or an object) executing the program of the work flow manager 46A to instruct the execution of the image processing by the image processor 50 to the work flow manager 46A.

The input of a processing request to each of the image processing modules 38 making up the image processor 50 allows the image processor 50 to perform the image processing. Hereinafter, prior to overall operation description of the image processor 50, processing performed by the buffer controller 40B of the individual buffer module 40, and processing performed by the controller 38B of the individual image processing module 38 are described in order.

In the exemplary embodiment, when the image processing module 38 writes the image data in the following buffer module 40, a writing request is inputted from the image processing module 38 to the buffer module 40. When the image processing module 38 reads the image data from the preceding buffer module 40, a reading request is inputted from the image processing module 38 to the buffer module 40.

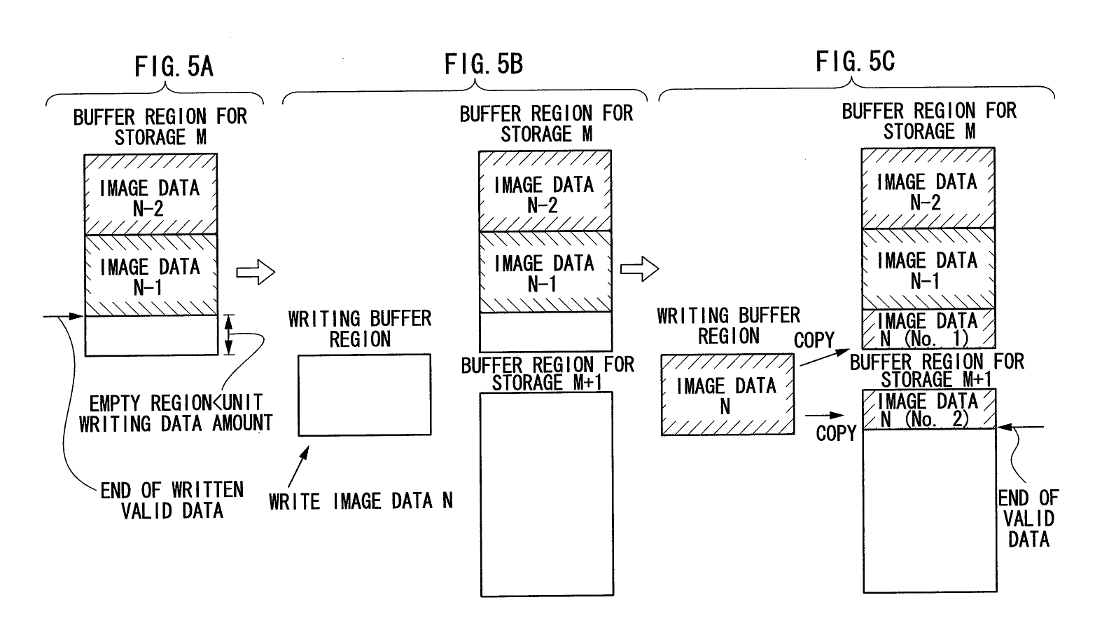

In the data writing processing, a unit writing data amount is notified to the resource manager 46B as a size of a memory region to be allocated. The memory region used for writing (writing buffer region: refer to FIG. 5B as well) is acquired through the resource manager 46B of the active processing manager 46. Next, it is determined whether or not a unit buffer region having an empty region of the unit writing data amount or more (unit buffer region where the unit writing data amount of image data can be written) exists in the unit buffer region for storage making up the buffer 40A of its own module. For the buffer module 40 generated by the module generator 44, the memory region used as the buffer 40A (unit buffer region) is not originally allocated, and every time shortage of the memory region occurs, a unit buffer region is allocated as a unit. Thus, when the writing request is first inputted to the buffer module 40, the memory region (unit buffer region) used as the buffer 40A does not exist, so that this determination is negative. After the unit buffer region used as the buffer 40A is allocated via the processing described later, if the empty region within the relevant unit buffer region becomes smaller than the unit writing data amount with the writing of the image data to the relevant unit buffer region, the above-described determination is also negative.

If it is determined that the unit buffer region having an empty region larger than the unit writing data amount (unit buffer region where the unit writing data amount of image data can be written) does not exist, the size of the memory region to be allocated (size of the unit buffer region) is notified to the resource manager 46B to acquire the memory region used as the buffer 40A of its own module (unit buffer region used for storing the image data) through the resource manager 46B. A head address of the relevant writing region is notified to the image processing module 38 of the writing request origin with the acquired writing buffer region as the writing region, and at the same time, a request to sequentially write the image data to be written from the notified head address is made. This allows the image processing module 38 of the writing request origin to write the image data in the writing buffer region, the head address of which is notified (refer to FIG. 5B as well).

For example, if the size of the unit buffer region is not an integral multiple of the unit writing data amount, repeating the writing of the unit writing data amount of image data to the buffer 40A (unit buffer region) results in a state where the size of an empty region in the unit buffer region having an empty region is smaller than the unit writing data amount as shown as an example in FIG. 5A. In this case, the region where the unit writing data amount of image data is written lies across the plural unit buffer regions. In the exemplary embodiment, however, since the memory region used as the buffer 40A is allocated on a basis of unit buffer region, it is not ensured that the unit buffer region allocated at different timings is a continuous region on the actual memory (memory 14). In order to address this, in the exemplary embodiment, the writing of the image data by the image processing module 38 is performed to the writing buffer region allocated aside from the unit buffer region for storage, and as shown in FIG. 5C, the image data once written in the writing buffer region is copied to a single or plural of unit buffer regions for storage. Thus, whether or not the region where the image data is written lies across the plural unit buffer regions, as the notification of the writing region to the image processing module 38 of the writing request origin, only the notification of its head address suffices as described above. This simplifies the interface with the image processing module 38.

If its own module is the buffer module 40 generated by the application 32, that is, if the memory region used as the buffer 40A has been already allocated, an address of the memory region already allocated is notified to the image processing module 38 as the address of the writing region, and the writing of the image data to the memory region is performed. When the writing of the image data to the writing region by the preceding image processing module 38 is completed, the attribute information is added to the image data written in the writing buffer region, and then, the image data is written in the buffer region for storage as it is. If the size of the empty region in the unit buffer region having the empty region is smaller than the unit writing data amount, the image data written in the writing buffer region is divided and written in the plural unit buffer regions for storage as shown in FIG. 5C.

The pointer indicating the end position of the valid data of the valid data pointers corresponding to the following individual image processing module 38 of its own module is updated so as to move forward the end position of the valid data indicated by the pointer by the unit writing data amount (refer to FIG. 5C as well). The memory region allocated as the writing buffer region is released by the resource manager 46B. In this manner, the data writing processing ends. A configuration may be such that the writing buffer region may be allocated at the initialization time of the buffer module 40, and it may be released at the deletion time of the buffer module 40.

Subsequently, the data reading processing executed by the buffer controller 40B of the buffer module 40 is described.

First, reading request information registered in the head is fetched from a reading queue. Based on request origin identification information included in the fetched reading request information, the image processing module 38 of the reading request origin is recognized, and a unit reading data amount set by the image processing module 38 of the reading request origin is recognized. Based on the valid data pointers corresponding to the image processing module 38 of the reading request origin, a head position and an end position on the buffer 40A of the valid data corresponding to the image processing module 38 of the reading request origin are recognized. Next, based on the recognized head position and the end position of the valid data, it is determined whether or not the valid data corresponding the image processing module 38 of the reading request origin (image data that the image processing module 38 of the reading request origin can read) has the unit reading data amount or more.

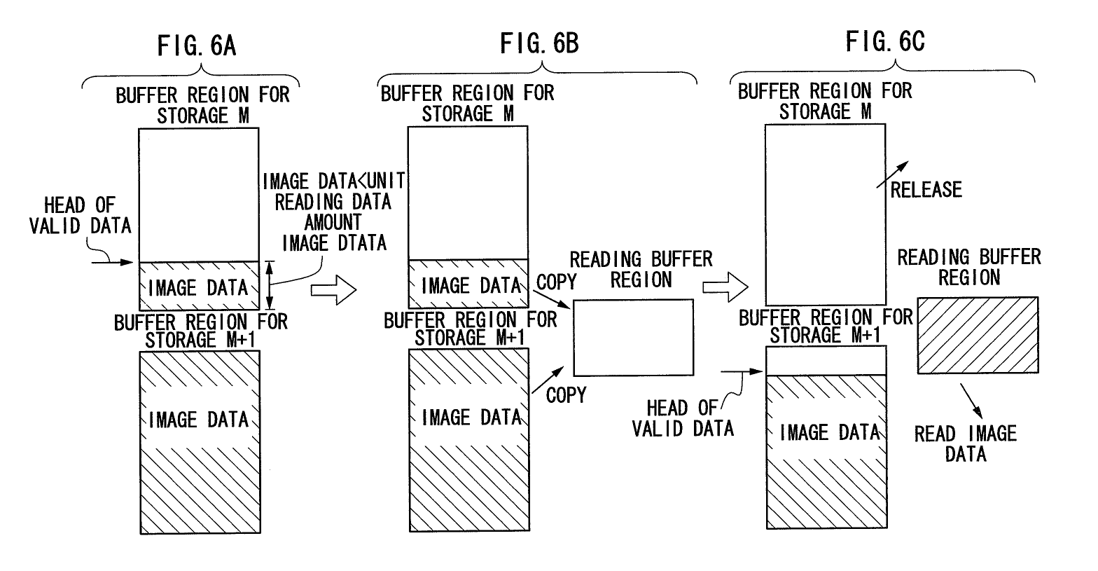

If the valid data corresponding to the image processing module 38 of the reading request origin is smaller than the unit reading data amount, it is determined whether or not the end of the valid data that the image processing module 38 of the reading request origin can read is an end of the image data to be processed. If the valid data corresponding to the image processing module 38 of the reading request origin stored in the buffer 40A is equal to or more than the unit reading data amount, or if the valid data corresponding to the image processing module 38 of the reading request origin stored in the buffer 40A is smaller than the unit reading data amount, but the end of the relevant valid data is the end of the image data to be processed, the unit reading data amount corresponding to the image processing module 38 of the reading request origin is notified to the resource manager 46B as a size of a memory region to be allocated, and at the same time, the allocation of the memory region used for reading (reading buffer region: refer to FIG. 6B as well) is requested to the resource manager 46B to acquire the reading buffer region through the resource manager 46B.

Next, the valid data to be read is read from the buffer 40A by the unit reading data amount and is written in the reading buffer region. Then, a head address of the reading buffer region is notified to the image processing module 38 of the reading request origin as a head address of the reading region, and at the same time, a request to sequentially read the image data from the notified head address is made. This allows the image processing module 38 of the reading request origin to read the image data from the reading region (reading buffer region) whose head address is notified. If the valid data to be read is data equivalent to the end of the image data to be processed, in requesting the reading of the image data, not only the size of the image data to be read but also the effect that the valid data to be read is equivalent to the end of the image data to be processed is notified to the image processing module 38 of the reading request origin. If its own module is the buffer module 40 generated by the application 32, the memory region used as the buffer 40A (aggregate of the unit buffer regions) is a continuous region. Thus, the allocation of the reading buffer region, and writing of the image data to be read in the reading buffer region may be omitted, and the following image processing module 38 may directly read the image data from the unit buffer region.

As shown as one example in FIG. 6A, if the data amount of the valid data stored in a unit buffer region storing image data of the head part of the valid data is smaller than the unit reading data amount, and the valid data to be read lies across plural unit buffer regions, the valid data to be read this time is not necessarily stored in a continuous region on the actual memory (memory 14). In the above-described data reading processing, however, as shown in FIGS. 6B and 6C, after the image data to be read has been written in the reading buffer region, the image data is read from the reading buffer region. Thus, whether or not the image data to be read is stored across the plural unit buffer regions, for the notification of the reading region to the image processing module 38 of the reading request origin, only the notification of the head address suffices as described above, which simplifies the interface with the image processing module 38.

When the completion of reading the image data from the reading region by the image processing module 38 of the reading request origin is notified, the head address and the size of the memory region allocated as the reading buffer region are notified to the resource manager 46B, and the memory region is released by the resource manager 46B. This reading buffer region may also be allocated at the initialization time of the buffer module 40, and be released when the buffer module 40 is deleted. Moreover, the pointer indicating the head position of the valid data of the valid data pointers corresponding the image processing module 38 of the reading request origin is updated by moving forward the head position of the valid data indicated by this pointer by the unit reading data amount (refer to FIG. 6C as well).

Next, referring to the valid data pointers corresponding to the following individual image processing modules 38, respectively, it is determined whether or not with the above-described pointer update, there has appeared a unit buffer region that has completed the reading of the stored image data by the following individual image processing module 38, that is, a unit buffer region in which the valid data is not stored among the unit buffer regions making up the buffer 40A. If the determination is negative, through the processing of checking the above-described reading queue (determination whether or not the reading request information is registered in the reading queue), the data reading processing ends. If the unit buffer region in which the valid data is not stored has appeared, the relevant unit buffer region is released by the resource manager 46B and then, through the processing of checking the reading queue, the data reading processing ends.

On the other hand, if the data amount of the valid data that is stored in the buffer 40A and the image processing module 38 of the reading request origin can read is smaller than the unit reading data amount, and the end of the readable valid data is not the end of the image data to be processed (in the case where the absence of readable valid data is sensed in FIG. 3(B) (4)), a data request for new image data is outputted to the work flow manager 46A (refer to FIG. 3B (5) as well). The reading request information fetched from the reading queue is reregistered again in the original queue (head or end thereof), and then through the processing of checking the reading queue, the data reading processing ends. In this case, the work flow manager 46A inputs a processing request to the preceding image processing module 38 of the relevant module. Thereby, the corresponding reading request information is held in the reading queue, and periodically fetched to repeatedly attempt the execution of the requested processing until it is sensed that the data amount of the readable valid data becomes the unit reading data amount or more, or that the end of the readable valid data is the end of the image data to be processed.

When a data request is inputted from the buffer module 40, the work flow manager 46A inputs a processing request to the preceding image processing module 38 of the buffer module 40 of the data request origin, whose details will be described later (refer to FIG. 3B (6) as well). When with the input of this processing request as a trigger, the processing performed in the controller 38B of the preceding image processing module 38 puts the preceding image processing module 38 into a state capable of writing the image data in the buffer module 40, and the input of a writing request from the preceding image processing module 38 allows the above-described data writing processing to be conducted. The image data is written from the preceding image processing module 38 into the buffer 40A of the buffer module 40 (refer to FIG. 3B (7), (8)). Thereby, the reading of the image data from the buffer 40A by the following image processing module 38 is performed (refer to FIG. 3B (9) as well).

The data reading processing described above is the data reading processing performed by the buffer controller 40B of the buffer module 40 with the exclusive access control function incorporated in the image processor 50 for parallel processing. The data reading processing performed by the buffer controller 40B of the buffer module 40 for sequential processing without the exclusive access control function incorporated in the image processor 50, is the same as the data reading processing described above except that the processing equivalent to the exclusive access control is not performed. That is, whether or not the buffer 40A is being accessed is determined, and if it is being accessed and the reading request information is registered in the queue, a timer is started. When the timer times out, whether or not the buffer 40A is being accessed is determined again, and the processing of checking whether or not the reading request information is left in the queue after the processing for a single reading request ends is no longer performed. Since the processing equivalent to the exclusive access control unnecessary in the sequential processing is omitted, the data reading processing in the buffer module 40 without the exclusive access control function may improve processing efficiency.

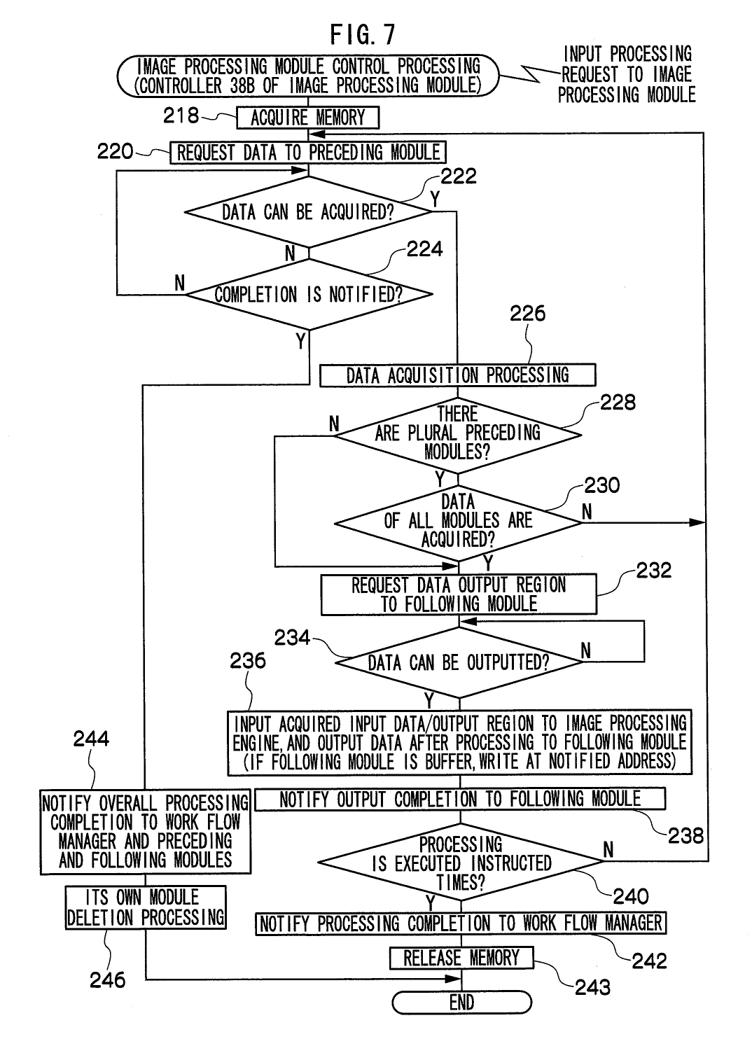

Subsequently, every time a processing request is inputted to each of the image processing modules 38 making up the image processor 50 from the work flow manager 46A, image processing module control processing (FIG. 7) performed by the controller 38B of the individual image processing module 38 is described.

In the image processing module control processing, first in step 218, the size of the memory used by its own module and the presence or absence of another resource used by its own module are recognized based on the type, contents and the like of the image processing performed by the image processing engine 38A of its own module. The memory used by the image processing module 38 is mainly a memory needed for the image processing engine 38A to perform the image processing. When the preceding module is the image data supplying unit 22, or when the following module is the image output unit 24, a memory for buffer may be needed to temporarily store the image data in transmitting and receiving the image data with respect to the preceding or following module. Moreover, when the processing parameter includes information such as a table, a memory region for retaining this may be necessary. The allocation of the memory region of the recognized size is requested to the resource manager 46B to acquire the memory region allocated by the resource manager 46B from the resource manager 46B. Moreover, when its is recognized that its own module (the image processing engine 38A thereof) needs resource other than the memory, the allocation of the above-mentioned another resource is requested to the resource manager 46B to acquire the above-mentioned another resource from the resource manager 46B.

In next step 220, when a module (buffer module 40, image data supplying unit 22, image processing module 38 or the like) exists at the preceding stage of its own module, data (image data or a processing result of the image processing such as analysis) is requested to the preceding module. In next step 222, whether or not the data can be acquired from the preceding module is determined. If the determination in step 222 is negative, whether or not the completion of the overall processing has been notified is determined in step 224. If the determination in step 224 is negative, the processing returns to step 222 to repeat steps 222, 224 until the acquisition of data from the preceding module is enabled. If the determination in step 222 is affirmative, the data is acquired from the preceding module in step 226, and data acquisition processing of writing the acquired data in a memory region for temporary storage of the data within the memory region acquired in step 218 is performed.

Here, in the case where the preceding module of its own module is the buffer module 40, if when the data is requested in step 220 (reading request), the readable valid data of the unit reading data amount or more is stored in the buffer 40A of the buffer module 40, or if the end of the readable valid data coincides with the end of the image data to be processed, a head address of the reading region is immediately notified from the buffer module 40 to request the reading of the image data. Alternatively, if the above condition is not satisfied, after with writing of the image data in the buffer 40A of the relevant buffer module 40 by the preceding image processing module 38 of the relevant buffer module 40, the above-described condition becomes satisfied, the head address of the reading region is notified from the buffer module 40 to request the reading of the image data. This makes the determination in step 222 affirmative, so that the processing goes to step 226. The unit reading data amount (or smaller than this) of image data is read from the reading region whose head address is notified from the preceding buffer module 40 to perform the data acquisition processing of writing the image data in the memory region for temporary storage (refer to FIG. 3A (3) as well).

Moreover, if the preceding module of its own module is the image data supplying unit 22, upon outputting the data request in step 220, it is immediately notified from the preceding data supplying unit 22 that the image data can be acquired. This makes the determination in step 222 affirmative, and the processing goes to step 226. The unit reading data amount of image data is acquired from the preceding image data supplying unit 22 to perform the image data acquisition processing of writing in the memory region for temporary storage. Moreover, in the case where the preceding module of its own module is the image processing module 38, upon outputting the data request (processing request) in step 220, a writing request to be inputted if the preceding image processing module 38 is in an executable state of image processing. This allows a data (image processing result)-acquirable state to be notified, which makes the determination in step 222 affirmative, and the processing goes to step 226. By notifying an address of the memory region for temporary storage where the data is written by the preceding image processing module 38 and requesting the writing, the data acquisition processing of causing the data outputted from the preceding image processing module 38 to be written in the memory region for temporary storage is performed.

In next step 228, it is determined whether or not plural modules are connected at the preceding stage of its own module. If the determination is negative, the processing goes to step 232 without performing any processing. If the determination is affirmative, the processing goes to step 230. It is determined whether or not the data has been acquired from all the modules connected at the preceding stage. If the determination in step 230 is negative, the processing goes to step 220 to repeat the series of processing from steps 220 to 230 until the determination in step 230 becomes affirmative. When all data to be acquired from the preceding modules is prepared, the determination in step 228 becomes negative, or the determination in step 230 becomes affirmative, and the processing goes to step 232.

In next step 232, a region for data output is requested to the following module of its own module, and the determination is repeatedly performed until the data output region can be acquired in step 234 (until a head address of the data output region is notified). In the case where the following module is a buffer module 40, the above-described request for the data output region is made by outputting a writing request to the buffer module 40. When the data output region (in the case where the following module is a buffer module 40, a writing region whose head address has been notified from the buffer module 40) can be acquired (refer to FIG. 3A (4) as well), in next step 236, the data acquired in the previous data acquisition processing, the data output region (the head address thereof) acquired from the following module, and the memory region (the head address and the size thereof) for image processing by the image processing engine in the memory region acquired in the previous step 218 are inputted to the image processing engine 38A. The inputted data is subjected to the predetermined image processing using the memory region for image processing (refer to FIG. 3A (5) as well). The processed data is written in the data output region (refer to FIG. 3A (6) as well). When the input of the unit reading data amount of data to the image processing engine 38A is completed, and the data outputted from the image processing engine 38A is all written in the data output region, the effect that the output has been completed is notified to the following module in next step 238.

The processing to the unit processing data amount of data (unit processing) in the image processing module 38 is completed through the above-described steps 220 to 238. In the processing request from the work flow manager 46A to the image processing module 38, the number of executions of the unit processing may be instructed by the work flow manager 46A. Thus, in step 240, it is determined whether or not the number of executions of the unit processing has reached the number of executions instructed by the inputted processing request. If the instructed number of executions of the unit processing is one, this determination is affirmative without condition. If the instructed number of executions of the unit processing is two or more, the processing returns to step 220 to repeat steps 220 to 240 until the determination in step 240 becomes affirmative. When the determination in step 240 becomes affirmative, the processing goes to step 242 to output a processing completion notification to the work flow manager 46A. This notifies the work flow manager 46A that the processing corresponding to the inputted processing request has been completed, and the image processing module control processing ends.

Moreover, the above-described series of processing is repeated every time a processing request is inputted from the work flow manager 46A, and the image data to be processed is processed to the end, when the completion of the image data to be processed is notified from the preceding module. This makes the determination in step 224 affirmative and the processing goes to step 244. An overall processing end notification meaning that the processing to the image data to be processed has ended is outputted to each of the work flow manager 46A and the following module (although in many cases, the image data to be processed is one page of image data, plural pages of image data may be employed). In next step 246, the release of all the acquired resources is requested, and the processing of deleting its own module is performed. Thereby, the image processing module control processing ends.

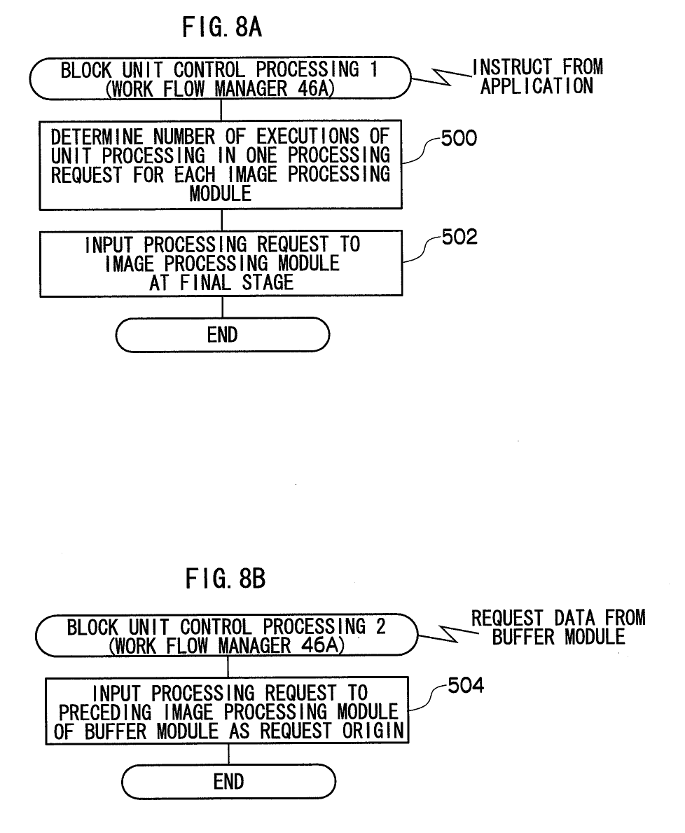

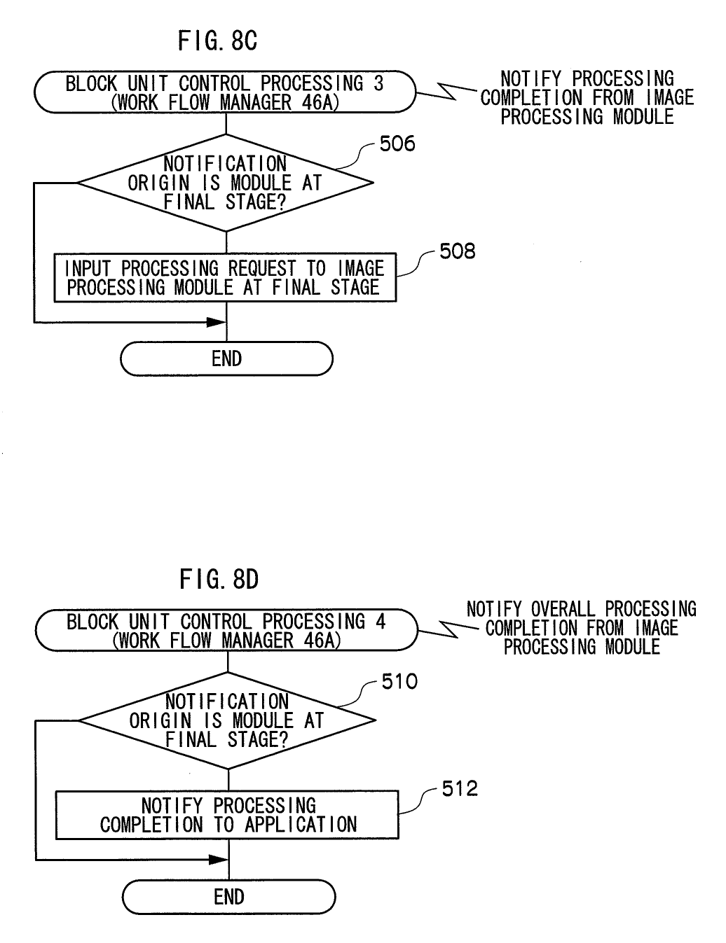

Upon receiving an instruction of the execution of the image processing, the work flow manager 46A performs block unit control processing 1 shown in FIG. 8A. The work flow manager 46A performs block unit control processing 2 shown in FIG. 8B every time a data request is inputted from a buffer module 40. The work flow manage 46A performs block unit control processing 3 shown in FIG. 8C every time a processing completion notification is inputted from an image processing module 38. The work flow manager 46A performs block unit control processing 4 shown in FIG. 8D every time an overall processing end notification is inputted from an image processing module 38.

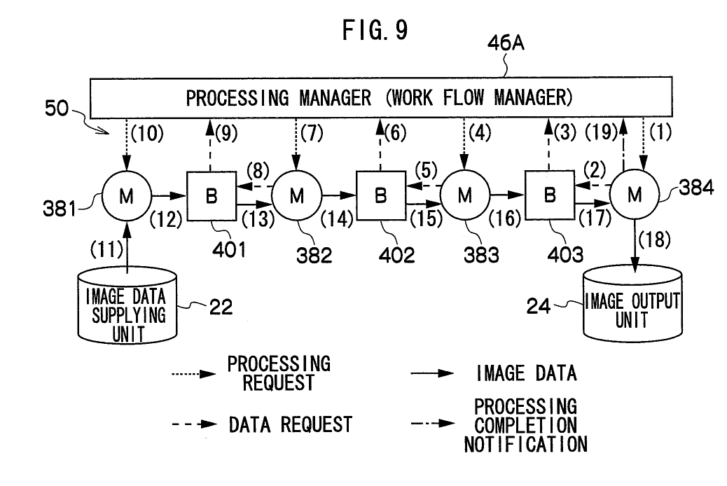

As described before, in the block unit control processing 1, for the input of the processing request to the individual image processing module 38 of the image processor 50 by the work flow manager 46A, the number of executions of the unit processing may be specified. In step 500, the number of executions of the unit processing specified in one processing request is determined for each of the image processing modules 38. This number of executions of unit processing per processing request may be fixed, for example, so as to average the number of inputs of the processing request to the individual image processing modules 38 during processing the overall image data to be processed. This, however, may be fixed in accordance with another rule. In next step 502, the processing request is inputted to the image processing module 38 at the final stage in the image processor 50 (refer to FIG. 9 (1) as well) to end the block unit control processing 1.

Here, in the image processor 50 shown in FIG. 9, when a processing request is inputted from the work flow manager 46A to an image processing module 38₄ at the final stage, the controller 38B of the image processing module 38₄ inputs a reading request to a preceding buffer module 40₃ (refer to FIG. 9 (2)). At this time, in the buffer 40A of the buffer module 40₃ is stored no valid data (image data) that the image processing module 38₄ can read. Thus, the buffer controller 40B of the buffer module 40₃ inputs a data request to the work flow manager 46A (refer to FIG. 9 (3)).

The work flow manager 46A performs the block unit control processing 2 shown in FIG. 8B every time the data request is inputted from the buffer module 40. In this block unit control processing 2, in step 504, the preceding image processing module 38 (in this case, an image processing module 38₃) of the buffer module 40 (in this case, the buffer module 40₃) of a data request input origin is recognized, and a processing request is inputted to the recognized preceding image proceeding module 38 to end the processing (refer to FIG. 9 (4)).

Upon receiving the input of the processing request, the controller 38B of the image processing module 38₃ inputs a reading request to a preceding buffer module 40₂ (refer to FIG. 9 (5)). Since no readable image data is stored in the buffer 40A of the buffer module 40₂, either, the buffer controller 40B of the buffer module 40₂ inputs a data request to the work flow manager 46A (refer to FIG. 9 (6)). Also, when the work flow manager 46A has the data request inputted from the buffer module 40₂, it again performs the block unit control processing 2 to thereby input a processing request to a preceding image processing module 38₂ (refer to FIG. 9 (7)). The controller 38B of the image processing module 38₂ inputs a reading request to a preceding buffer module 40, (refer to FIG. 9 (8)). Also, since no readable image data is stored in the buffer 40A of the buffer module 40₁, the buffer controller 40B of the buffer module 40, inputs a data request to the work flow manager 46A (refer to FIG. 9 (9)). When the work flow manager 46A has the data request inputted from the buffer module 40₁, it also performs the above-described block unit control unit 2 again to thereby input a processing request to a preceding image processing module 38₁ (refer to FIG. 9 (10)).

Here, since the preceding module of the image processing module 38₁ is the image data supplying unit 22, the controller 38B of the image processing module 38, acquires the unit reading data amount of image data from the image data supplying unit 22 by inputting a data request to the image data supplying unit 22 (refer to FIG. 9 (11)). The controller 38B writes, in the buffer 40A of the following buffer module 40₁, the image data obtained by the image processing engine 38A performing the image processing to the acquired image data (refer to FIG. 9 (12)).

Once equal to or more than the unit reading data amount of valid data that the following image processing module 38₂ can read is written, the buffer controller 40B of the buffer module 40₁ requests the reading to the image processing module 38₂. With this, the controller 38B of the image processing module 38₂ reads the unit reading data amount of image data from the buffer 40A of the buffer module 40₁ (refer to FIG. 9 (13)). The controller 38B of the image processing module 38₂ writes, in the buffer 40A of the following buffer module 40₂, the image data obtained by the image processing engine 38A performing the image processing to the acquired image data (refer to FIG. 9 (14)). Once equal to or more than the unit reading data amount of valid data that the following image processing module 38₃ can read is written, the buffer controller 40B of the buffer module 40₂ requests the reading to the image processing module 38₃. The controller 38B of the image processing module 38₃ reads the unit reading data amount of image data from the buffer 40A of the buffer module 40₂ (refer to FIG. 9 (15)). The controller 38B of the image module 38₃ writes, in the buffer 40A of the following buffer module 40₃, the image data obtained by the image processing engine 38A performing the image processing to the acquired image data (refer to FIG. 9 (16)).

Furthermore, once equal to or more than the unit reading data amount of valid data that the following image processing module 38₄ can read is written, the buffer controller 40B of the buffer module 40₃ requests the reading to the image processing module 38₄. With this, the controller 38B of the image processing module 38₄ reads the unit reading data amount of image data from the buffer 40A of the buffer module 40₃ (refer to FIG. 9 (17)). The controller 38B of the image module 38₄ outputs the image data obtained by the image processing engine 38A performing the image processing to the acquired image data to the image output unit 24 as the following module (refer to FIG. 9 (18)).

Moreover, upon completing writing the image data to the buffer 40A of the following buffer module 40, the controller 38B of the individual image processing module 38 inputs a processing completion notification to the work flow manager 46A. Every time the processing completion notification is inputted from the image processing module 38, the work flow manager 46A performs the block unit control processing 3 shown in FIG. 8C. In this block unit control processing 3, in step 506, it is determined whether or not the image processing module 38 of the processing completion notification origin is the image processing module 38 at the final stage. If this determination is negative, the block unit control processing 3 ends without performing any processing. If the determination is affirmative, the processing goes to step 508. The processing request is again inputted to the image processing module 38 of the processing completion notification origin to end the processing.

Every time an overall processing end notification is inputted from the image processing module 38, the work flow manager 46A performs the block unit control processing 4 shown in FIG. 8D. In this block unit control processing 4, in step 510, it is determined whether or not the image processing module 38 of the overall processing end notification input origin is the image processing module 38 at the final stage. If the determination is negative, the processing ends without performing any processing. All the image data resulting from subjecting the image data to be processed to necessary image processing is outputted to the image output unit 24, and when the overall processing end notification is inputted from the image processing module 38 at the final stage is inputted, the determination in step 510 is affirmative and the processing goes to step 512. The completion of the image processing is notified to the application 32 (refer to step 178 of FIG. 4 as well) to end the block unit control processing. The application 32 to which the completion of the image processing has been notified notifies the completion of the image processing to the user (refer to step 180 of FIG. 4 as well).

In this manner, in the block unit processing, the processing request inputted to the image processing module 38 at the final stage goes back to the preceding image processing module 38, and when the most preceding image processing module 38 is reached, the image processing is performed in the most preceding image processing module 38 to write the data in the following buffer module 40. When the data is enough, the processing advances to the following modules. In such a flow, the series of image processing is performed.

In the foregoing, an aspect is described in which the work flow manager 46A controls in such a manner that the individual image processing module 38 of the image processor is operated so as to perform the image processing while passing the image data to the following stage on a basis of data amount smaller than one surface of an image, by which the image processor performs the block unit processing as a whole. The invention, however, is not limited to this. The work flow manager 46A may be configured so that the individual image processing module 38 of the image processor is operated in such a manner that after the preceding image processing module 38 completes the image processing to one surface of image data, the following image processing module 38 performs the image processing to one image surface of image data, by which the image processor may perform surface unit processing as a whole.

Moreover, the error manager 46C of the processing manager 46 also operates while the work flow manager 46A is performing the control as described above. When an error occurs in the middle of execution of the image processing by the image processor 50, the error manager 46C acquires error information such as a type/occurrence location, and acquires, from the storage unit 20 or the like, device environment information indicating a type, configuration and the like of the equipment in which the computer 10 with the image processing program group 34 installed is incorporated. The error manager 46C determines an error notification method in accordance with the device environment indicating the acquired device environment information to perform the processing of notifying the occurrence of the error in the determined error notification method.

The overall configuration and processing in the exemplary embodiment have been described hereinbefore.

Hereinafter, details of the determination on the execution order of image processing in step 166 are described. More specifically, processing is described in which a number of sections (groups) for sectioning (dividing, splitting) the plural image processing modules (image processing unit) into plural groups is acquired (section (group) number acquisition unit), and the respective image processing modules are caused to belong to the respective groups to thereby section (divides, splits) the plural image processing modules (sectioning (dividing, split) unit), based on the acquired number of sections (groups) and the order of the image processing that the image processing modules execute.

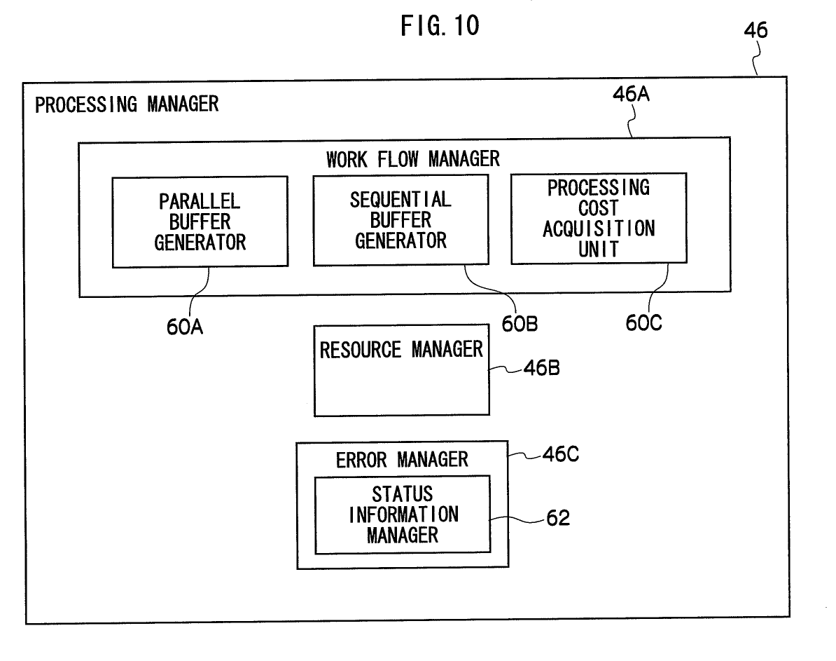

First, a configuration for executing the sectioning processing is described with reference to FIG. 10. FIG. 10 is a diagram showing a detailed configuration of the processing manager 46 described in FIG. 1. As shown in this figure, in the work flow manager 46A, a parallel buffer generator 60A, a sequential buffer 60B, and a processing cost acquisition unit 60C are provided. The parallel buffer denotes a buffer module that executes processing to a request from each of the image processing modules connected at the preceding and following stages with exclusive access control. The parallel buffer generator 60A generates this buffer module. Each of the requests from the image processing modules, which is a request on the storage of image data, is the image data request and the image data writing notification as described in FIGS. 3A to 3B. The processing executed to these requests by the parallel buffer is an exclusive access storage processing step.

Moreover, the sequential buffer is a buffer module that sequentially executes the processing to a request from each of the image processing modules without performing the exclusive access control. The sequential buffer generator 60B generates this buffer module. Similar to the parallel buffer, the request on storage from each of the image processing modules is the image data request and the image data writing notification as described in FIGS. 3A to 3B. The processing executed to these requests by the sequential buffer is a sequential storage processing step.

The processing cost acquisition unit 60C acquires a processing amount (processing cost) needed for the image processing module to execute the processing from a module table, which will described later.

Moreover, a status information manager 62 provided in the error manager 46C manages a status of the image processing module, and executes processing to address error occurrence.

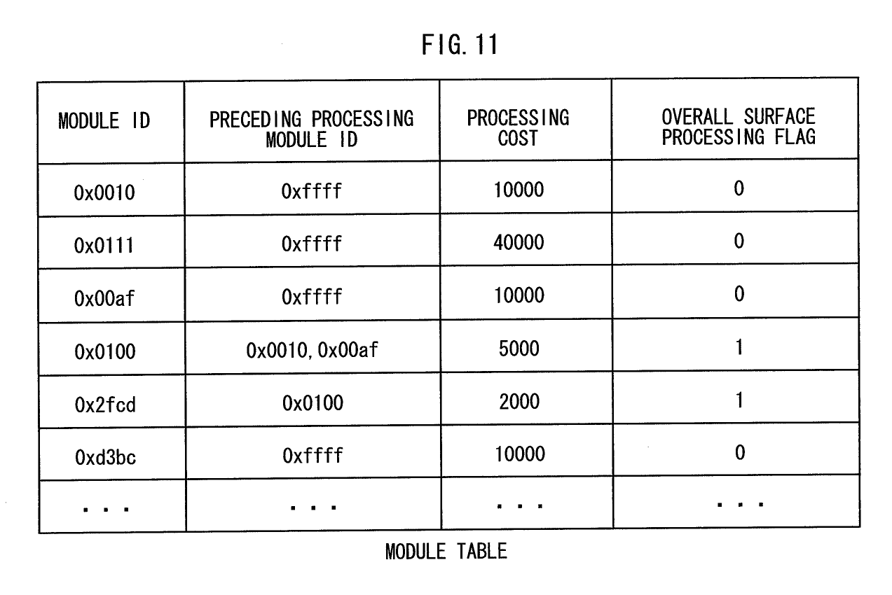

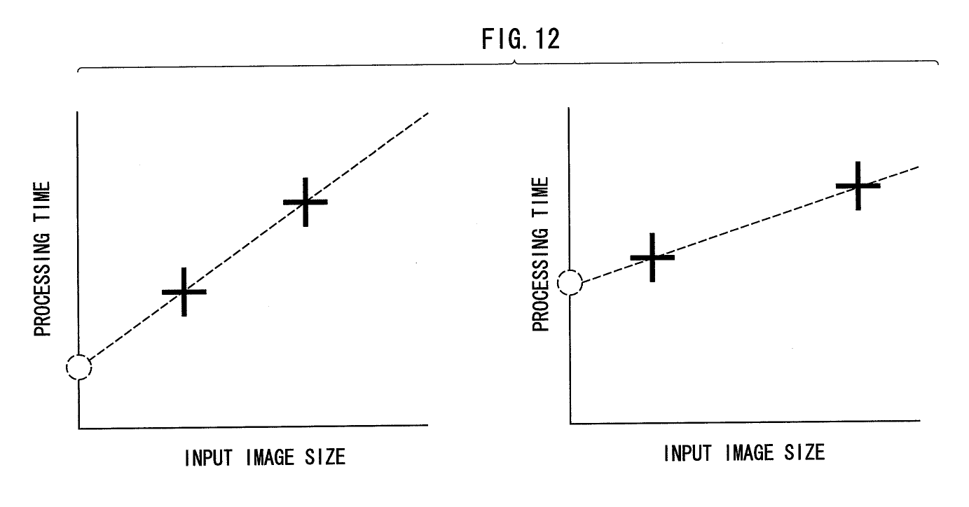

Next, referring to FIG. 11, the above-mentioned module table is described. As described in this figure, the module table is a table indicating module IDs, preceding processing module IDs, processing costs, and overall surface processing flag.

The module ID is identification information represented in hexadecimal for identifying each image processing module. The preceding processing module ID is an ID of the image processing module connected at the preceding stage of the relevant image processing module. If the relevant image processing module is in the head, the module ID thereof is 0xfff.

The overall surface processing flag is a flag having a value of 1 when the processing cannot be executed unless an overall input image is prepared, such as a case where image processing by the other image processing modules all end, and otherwise, having a value of 0. For example, as in image rotation processing, in the case where the processing cannot be performed unless an overall image is prepared, the overall surface processing flag becomes 1.

Since an image processing module whose module ID is 0x0100 as shown in the same figure has the overall processing flag of 1, it is the image processing module that cannot execute the processing unless the image processing by the image processing modules having module IDs of 0x0010 and 0x00af end.

The processing cost is indicated by a CPU processing time for example, as shown in the same figure. This CPU processing time may be fixed in advance as shown in the same figure by executing each of the image processing modules in advance. The processing cost may, however, vary depending on an input image size and a processing parameter. Thus, the processing cost is found by giving plural groups of parameters relating to the processing, such as input image sizes for each processing to establish a predetermined calculating formula for calculation.

For example, in the case of convolution filter processing, the processing cost largely depends on the input image size and a filter coefficient size (3×3, 5×5, and so on). As shown in FIG. 12, two input image sizes, and two filter coefficient sizes may be assigned to find their processing costs, and by linear interpolation filling a void, a prediction formula may be found.

The image attribute may be fixed (to 8 bits and 3 channels or the like). In the case where the processing is enabled with other attributes (16 bits and 3 channels, 8 bits and 1 channel and the like), a more accurate processing cost may be acquired by establishing a prediction formula for each attribute.

Furthermore, in the case of scaling-up/down processing, the processing cost largely depends on the input image size and a magnification (=output image size). Consequently, two input image sizes and two magnifications may be assigned to find their processing costs, and by linear interpolation filling a void, a prediction formula may be found.

In this case, a prediction formula for each attribute is also needed in image data having different image attributes. In the case where the interpolation method of the scaling-up/down (nearest neighbor method, linear interpolation, projection method and so on) differs, establishing a prediction formula for each method allows more precise processing cost to be acquired.

As in the example described above, values may be assigned two-by-two. By assigning three or more, an approximate curve may be found or an N-th order function may be used for approximation. Alternatively, since the processing parameter having an effect is not necessarily one, plural parameters may be used. However, since the use of an exact prediction formula that may increase the processing cost more than necessary impractically takes a lot of time in processing, it is preferable to use a simple prediction formula by narrowing down to main ones having an effect (depending on the contents of processing and an implement method).

This processing cost does not need to be a specific value such as a processing time as shown in the same figure. Since the comparison with the result of another module suffices, a ratio with an appropriate value set as one, or the like may be employed.

Hereinafter, prior to descriptions of the respective processing with reference to flowcharts, relations between a group and a thread are described.

The group in the exemplary embodiment denotes an aggregate of one or more image processing modules for executing processing as a thread.

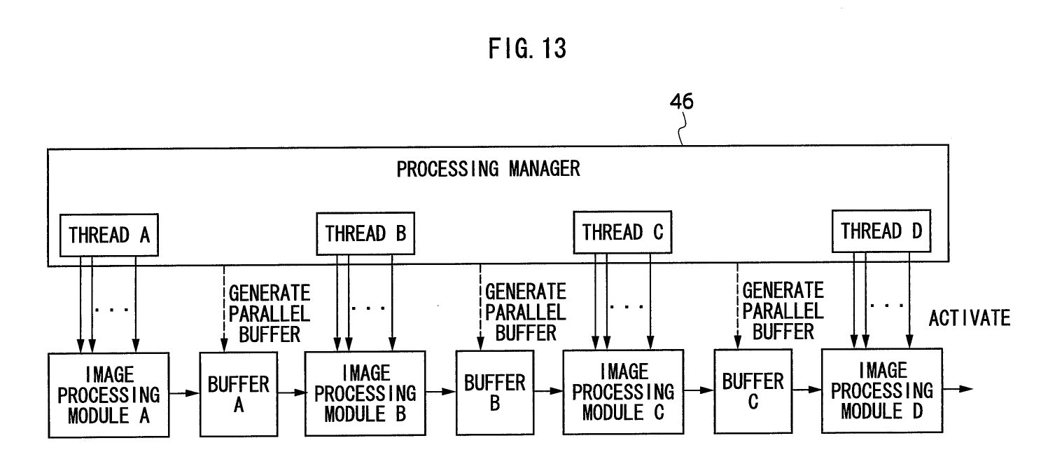

Accordingly, the image processing executed by all image processing modules belonging to the above-described group is processing as one thread. For example, FIG. 13 shows a thread configuration in which four image processing modules are sectioned into four groups. In this case, the processing is executed by one image processing module as one thread.

As shown in the same figure, each parallel buffer receives a request on storage of image data from the image processing module belonging to a different group.

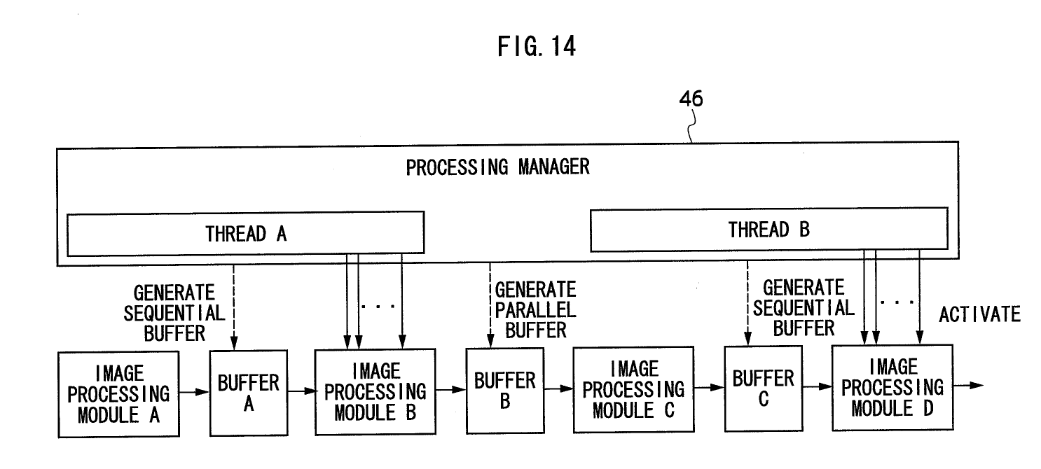

Next, referring to FIG. 14, a thread configuration example in the case where plural image processing modules belong to one group is described.

The same figure shows a thread configuration example in the case where four image processing modules are sectioned into two groups. More specifically, a thread A consists of image processing modules A, B, and a thread B consists of image processing modules C, D.

Since in the image processing module A and the image processing module B, the processing is sequentially performed by the same thread A, requests to a buffer A are not made simultaneously, so that the buffer A may operate as a sequential buffer, which does not perform exclusive access control. On the other hand, since in the image processing module B and the image processing module C, the processing are performed in parallel by the different threads A and B, requests to a buffer B may be made simultaneously from the threads A and B. For the image processing module B and the image processing module C, the buffer B, thus, needs to be a parallel buffer, which operates while performing exclusive access control.

Similar to the buffers shown in FIG. 13, the buffer B receiving requests on storage of the image data from the image processing modules B, C belonging to different groups is a parallel buffer. Each of the buffer A and a buffer C is a sequential buffer receiving requests on storage of the image data from image processing modules belonging to the same group.

In this manner, in the exemplary embodiment, the buffer receiving requests on storage of the image data from the image processing modules belonging to the same group is a sequential buffer. The buffer receiving requests on storage of the image data from the image processing modules belonging to different groups is a parallel buffer.

Hereinafter, referring to flowcharts, the processing of sectioning plural image processing modules into groups is described.

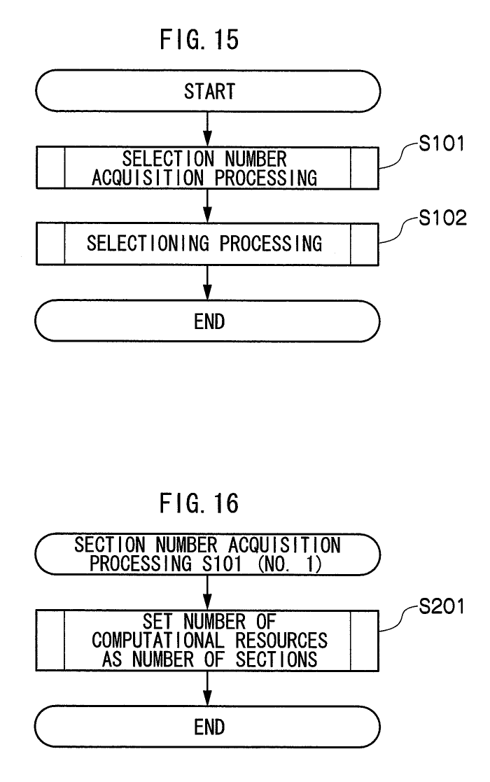

A flowchart shown in FIG. 15 shows fundamental processing of sectioning plural image processing modules into groups. First, in step 101 in the same figure, section number acquisition processing of acquiring the number of sections for sectioning the plural image processing modules is executed.

In step 102, by causing the respective image processing modules to belong to the respective groups based on the acquired number of sections and the order of image processing executed by the image processing modules, the sectioning processing for sectioning the plural image processing modules is executed.

First, the section number acquisition processing is described. A flowchart shown in FIG. 16 indicates section number acquisition processing (No. 1). This processing is processing in which the number of computational resources is set as the number of sections in step 201. The number of computational resources may be acquired by a function provided by OS or the like.

The computational resource executes computation according to the image processing, and particularly, the computational resource in the exemplary embodiment is a computational unit that may execute computation according to the image processing in parallel. The image processing module executes the image processing to the image data by the computational resource.

More specifically, the computational resource is a CPU core, DSP (Digital Signal Processor) or the like, and denotes a resource that may execute the computation according to the image processing in parallel. Since some recent CPUs have a hyper-thread function or have cores placed in two layers, the seeming number of CPUs may be different from the number of computational resources.

For example, in the case of a CPU in which there is one thread capable of parallel processing in one core, and the number of cores are two, the number of computational resources is two. Moreover, in a CPU in which there are two threads capable of parallel processing in one core, and the number of cores is two CPU, the number of computational resources is four.

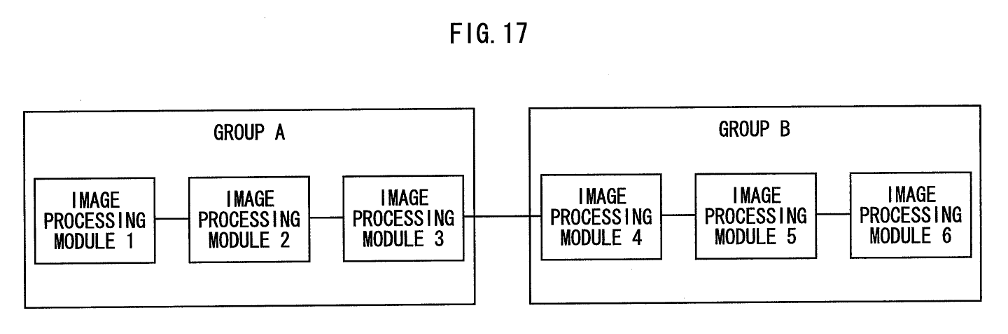

As in the above step 201, the example in which the number of computational resources is simply set as the number of groups is shown in FIG. 17. FIG. 17 is a diagram showing a sectioning example, in which six image processing modules are sectioned into two groups.

In the case where such simple sectioning is performed, continuous modules are connected through a sequential buffer, and groups are connected through a parallel buffer. Thus, extra exclusive access control does not need to be performed in the sequential buffer, which may increase parallelization efficiency.

As in a specialized image processing machine, in the case where relatively, other threads do not move, the number of computational resources may be simply set as the number of sections. In contrast, as in a general-purpose personal computer, in the case where another process uses the computational resource, competition with the image processing may decrease the processing efficiency.

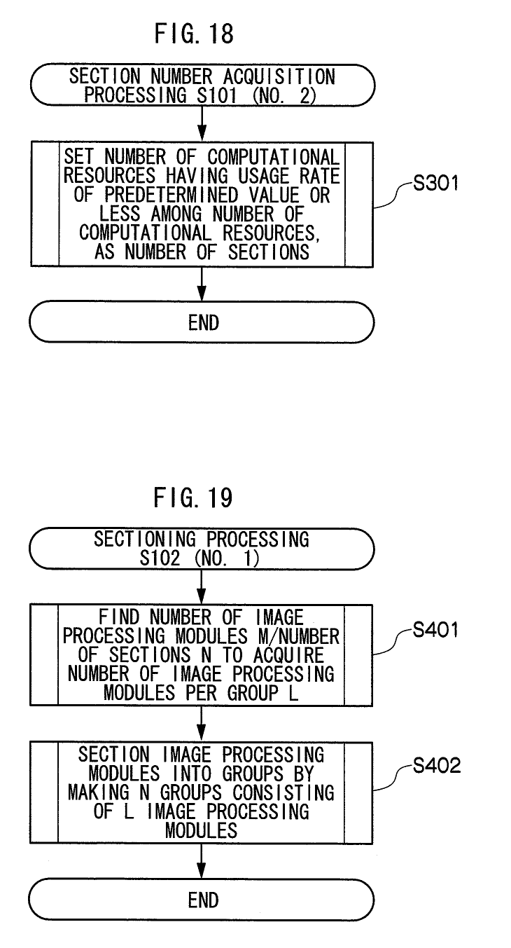

Thus, as shown in section number acquisition processing (No. 2) illustrated in FIG. 18, in step 301, among the computational resources, the number of computational resources, the usage rate of which is a predetermined value or less, is set as the number of sections to thereby avoid the possibility of decreasing the processing efficiency. As the predetermined value in this case, a CPU usage rate of 20% is exemplified.

In the foregoing, details of the section number acquisition processing were given. Next, details of sectioning processing (step 102) are described.

FIG. 19 is a flowchart showing the sectioning processing (No. 1). First, in step 401, (the number of image processing modules M)/(the number of sections N) is found to acquire the number of image processing modules per group L. The number of sections N is acquired from the above-described sectioning number acquisition processing. In step 402, by creating N groups each consisting of L image processing modules, the image processing modules are sectioned into the groups. If the fraction cannot be represented by an integer, all digits to the right of the decimal point in L are discarded to thereby execute the processing with L of an integer. This processing allows the image processing modules that do not belong to any group to belong to appropriate groups.

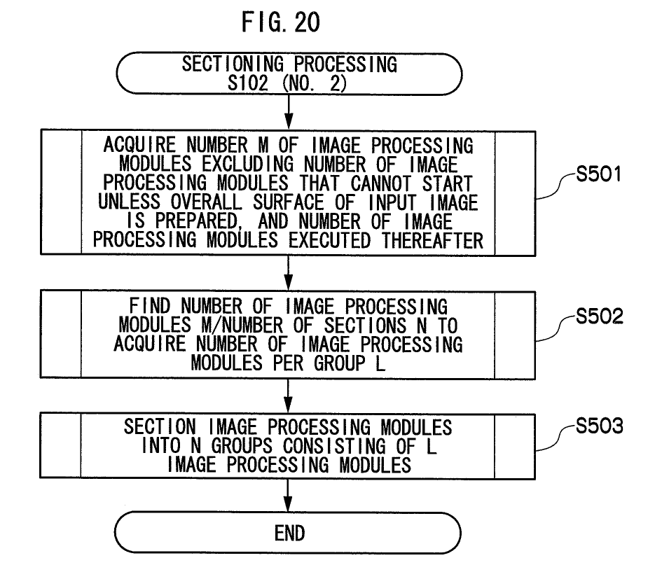

Next, the sectioning processing in the case where an image processing module having preceding processing thereof is included is described with reference to FIG. 20. If there is any image processing module necessary for the preceding processing as described above, the relevant image processing module and all the following modules cannot start the processing even when threads are assigned. Consequently, in step 501 is acquired the number of image processing modules M excluding the number of the image processing modules that cannot start the processing unless an overall input image surface is prepared and the image processing modules to be executed after the relevant image processing module is executed. This processing is executed with reference to the overall surface flag in the module table. In subsequent steps 502, 503, the same processing as those in the steps 401, 402, are executed, respectively.

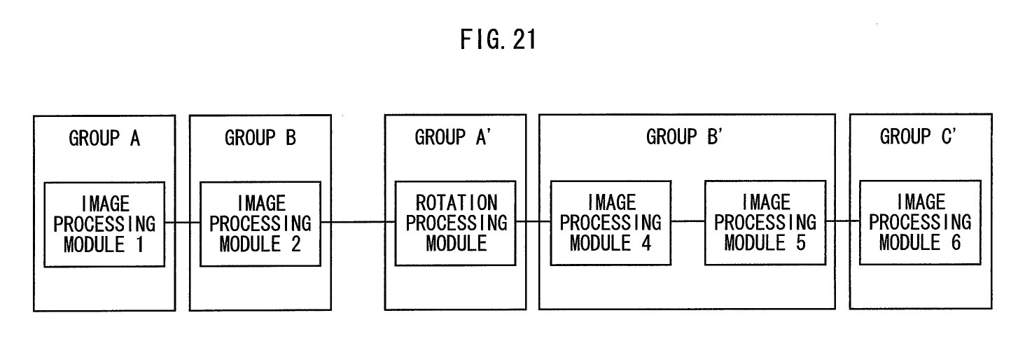

In this case, for example, as shown in FIG. 21, only the image processing modules before the rotation processing module having the preceding processing are first sectioned into groups (groups A, B) and processed in parallel. After this, the remaining image processing modules including the rotation processing module are sectioned into groups (groups A′, B′, C′) to continue the processing. In this case, a description is given on the assumption that the number of sections is 3. Since there are only two image processing modules before the rotation processing module, the respective image processing modules only need to be set as the groups.

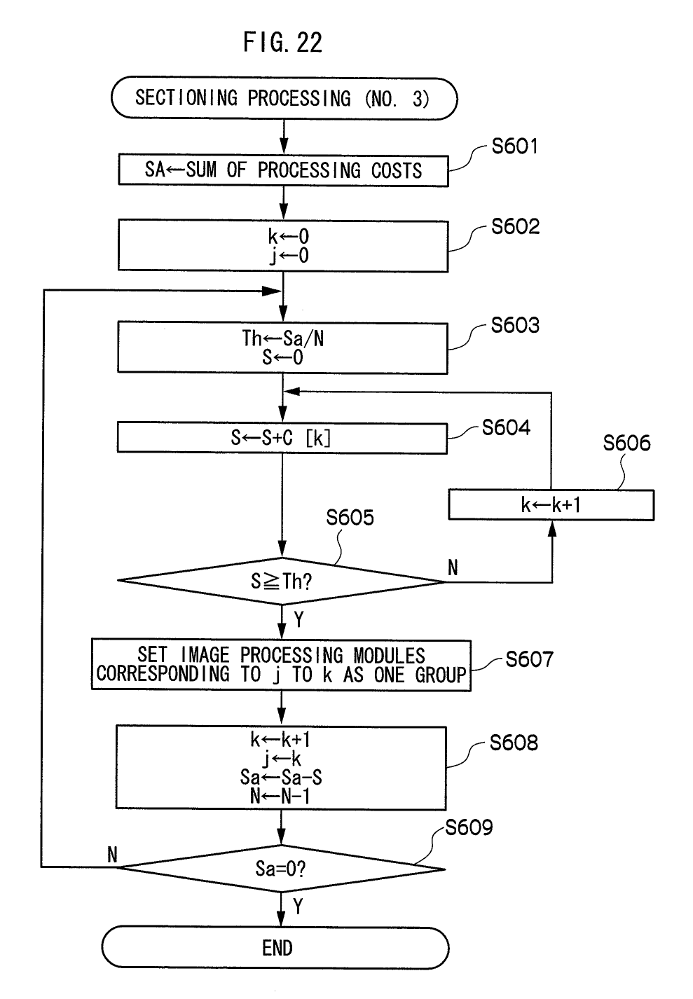

Next, the sectioning processing (No. 3) in view of the processing cost is described with reference to a flowchart in FIG. 22. The sum of processing costs is first assigned to Sa in step 601. This processing is executed with reference to the processing costs in the module table. In next step 602, 0 is assigned to variables k, j for specifying the image processing module.

In next step 603, Sa/N, is assigned to Th, and 0 is assigned to S, where N indicates the number of groups, and Th indicates a threshold of processing cost per group. S is a variable used for calculation of the processing cost.

Next, in step 604, S+C[k] is assigned to S, where C[k] is an array indicating the processing cost of the k-th image processing module.

Next, in step 605, it is determined whether or not S is the threshold Th or more. If the determination in step 604 is negative, since S has not reached the processing cost per group, k is incremented by 1, and the processing is executed again in step 604.

On the other hand, if the determination in step 605 is affirmative, since S has reached the processing cost per group, the image processing modules corresponding to j to k are sectioned into one group in step 607.

In next step 608, k+1 is assigned to k, k to j, Sa−S to Sa, and N−1 to N, respectively. In next step 609, it is determined whether or not Sa is 0, that is, whether or not the processing cost is 0. If the processing cost is 0, it indicates that the processing of sectioning the image processing module into the group has ended, so that the relevant processing ends. On the other hand, if the processing cost is not 0, it indicates that the processing of sectioning the image processing module into the group has not ended, so that the processing in step 603 is again executed.

In the processing, the threshold Th is found from Sa/N. When the image processing modules are sequentially grouped from the head, in many cases, the processing cost may become a little heavier in each of the preceding modules. In order to alleviate this, Th=(Sa/N)×0.9 or the like may be set for adjustment, or for the head group, 0.9 is employed, and for the following groups, the value may be made closer to 1.0 little by little.

In the case where processing is executed in a configuration such as DAG, if the preceding processing is delayed, rate-determining control occurs at the following stage, and thus, it is preferable that the image processing module that executes a little lighter processing is set at the preceding stage. Consequently, it may also be considered that the grouping is performed reversely from the aftermost image processing module by the above-described sectioning processing (No. 3). A solution closest to uniformity is found using a dynamic programming or the like. However, since generally, the number of connections of the image processing modules is not so large, the uniformity cannot be achieved, and this processing may lengthen the processing time as a whole.

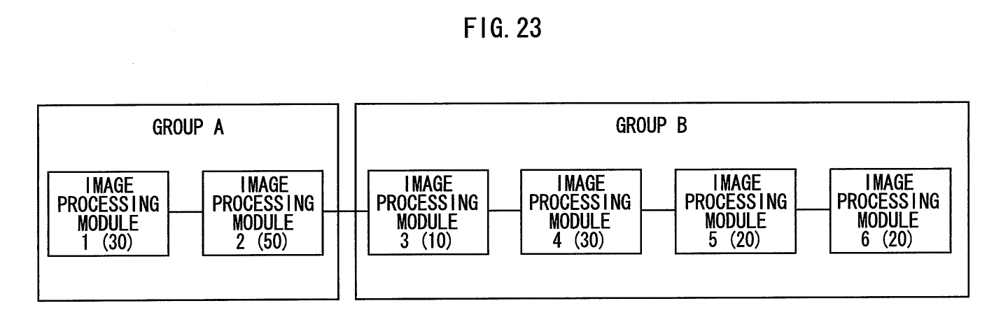

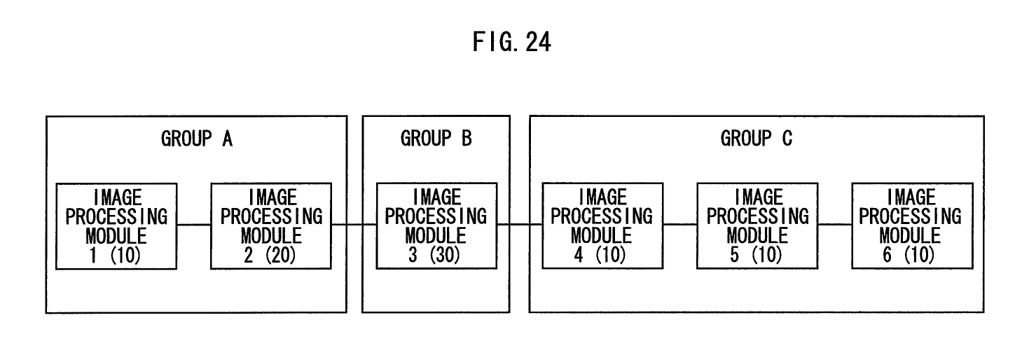

Sectioning examples are shown in FIGS. 23 and 24. FIG. 23 shows an example in which six image processing modules are sectioned with Th set to 80. Numbers in parentheses indicate processing costs.

The processing cost of an image processing module 1 belonging to the group A is 30, and the processing cost of an image processing module 2 is 50. Accordingly, the processing cost in the overall group A is 80. The processing cost of an image processing module 3 belonging to the group B is 10, the processing cost of an image processing module 4 is 30, the processing cost of an image processing module 5 is 20, and the processing cost of an image processing module 6 is 20. Accordingly, the processing cost in the overall group B is 80.

Moreover, FIG. 24 shows an example in which six image modules are sectioned with Th set to 30.

The processing cost of the image processing module 1 belonging to the group A is 10, and the processing cost of the image processing module 2 is 20. Accordingly, the processing cost in the overall group A is 30. The processing cost of the image processing module 3 belonging to the group B is 30, so that the processing cost in the overall group B is 30.

The processing cost of the image processing module 4 belonging to the group C is 10, the processing cost of the image processing module 5 is 10, and the processing cost of the image processing module 6 is 10. Accordingly, the processing cost in the overall group C is 30.

In this manner, the grouping is performed so that the processing costs of the respective groups are nearly uniform based on the processing costs of the respective image processing modules or their ratios.

By sectioning so that the processing costs are nearly uniform in this manner, the efficient parallel processing may be realized as compared with the case of simple sectioning. For example, if the group A in FIG. 17 accounts for 90% of the overall processing cost, the group B proceeds with the processing after the result of the group A is obtained, and as a result, the parallelization improves the efficiency only by a factor of (100/90=1.11). However, by sectioning so that the processing costs are substantially equal in the respective groups as described above, the efficient parallel processing may be executed.

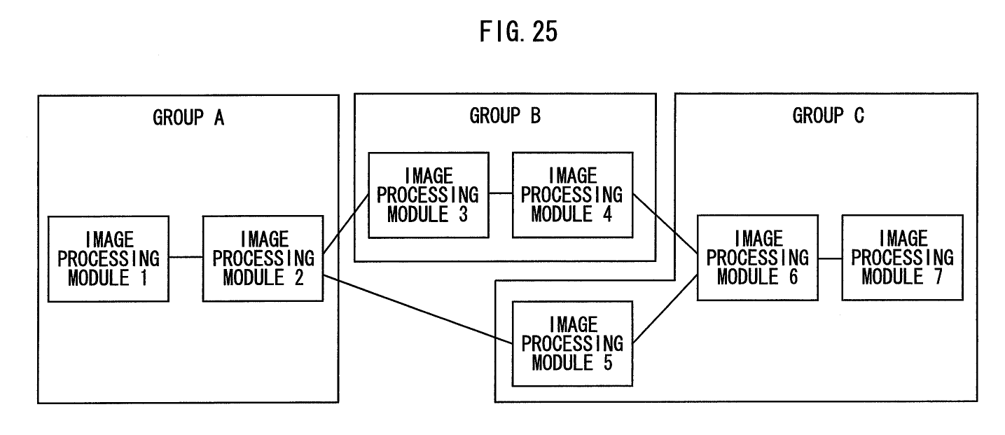

According to the section number acquisition processing and the sectioning processing, the module table (refer to FIG. 11) has the modules IDs of the preceding processing. Accordingly, if there exists an image processing module having two preceding processing, such as the image processing module having the module ID of 0x0100 shown in the module table, the modules are sectioned into the groups as shown in FIG. 25. In this case, the preceding processing of the image processing module 6 are equivalent to the image processing module 4 and the image processing module 5.

While in the exemplary embodiment, the case where the program of the processing manager 46 is stored in the storage unit 20 in a fixed manner is described, the invention is not limited to this. A program of a new processing manager (parallel processing manager or sequential processing manager) may be added from outside of the computer 10 through an external storage device such as a USB memory, for example, a communication lines and the like, or the registered program of the processing manager may be overwritten and updated. The optimum parrallelization method may be changed in accordance with the employment of a new architecture of the CPU 12 or the like. Also, it may be difficult to provide a program of an optimum processing manager from the beginning, or a higher-efficiency algorithm may be newly developed as algorithm of the processing manager in the future. In light of such cases, it is desirable that a processing managing library 47 of the storage unit 20 is configured so that the new addition of a program of a processing manager and overwriting update are enabled.

Moreover, in the foregoing, the aspect in which the image processing program group 34 corresponding to the image processing program according to the invention is stored (installed) in the storage unit 20 in advance is described. However, the image processing program according to the invention may be provided in a form of being recorded in a recording medium such as a CD-ROM, and DVD-ROM.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

According to a first aspect of the invention, there is provided an image processing apparatus comprising: a plurality of computational units that execute computation related to image processing; a plurality of image processing units that cause the computational units to execute image processing on image information; a section number acquisition unit that acquires a number of sections for sectioning the plurality of image processing units into a plurality of groups; a sectioning (dividing, split) unit that sections (divides, splits) the plurality of image processing units by causing the respective image processing units to belong to the respective groups based on the number of sections acquired by the section number acquisition unit and the order of the image processing that the image processing units cause the computational units to execute; a sequential storage processing unit that receives requests for storage of the image information from image processing units belonging to the same group, and sequentially executes processing of the requests from the image processing units without performing exclusive access control; and an exclusive access storage processing unit that receives requests for storage of the image information from image processing units belonging to different groups, and executes processing of the requests from the image processing units while performing exclusive access control.

According to a second aspect of the invention, there is provided a computer readable medium storing a program causing a computer to execute a process for image processing, the process comprising: acquiring a number of sections for sectioning into a plurality of groups a plurality of image processing units that cause a plurality of computational units that execute computation relating to image processing to execute image processing on image information; sectioning (dividing, splitting) the plurality of image processing units by causing the respective image processing units to belong to the respective groups based on the acquired number of sections and based on the order of the image processing that the image processing units cause the computational units to execute; receiving requests for storage of the image information from image processing units belonging to the same group, and sequentially executing processing of the requests from the image processing units without performing exclusive access control; and receiving requests for storage of the image information from image processing units belonging to different groups, and executing processing of the requests from the image processing units while performing exclusive access control.

What is claimed is:

1. An image processing apparatus comprising:
a plurality of computational units that execute computation related to image processing;
a plurality of image processing units that cause the computational units to execute image processing on image information;
a section number acquisition unit that acquires a number of sections for sectioning the plurality of image processing units into a plurality of groups;
a sectioning unit that sections the plurality of image processing units by causing the respective image processing units to belong to the respective groups based on the number of sections acquired by the section number acquisition unit and the order of the image processing that the image processing units cause the computational units to execute;
a sequential storage processing unit that receives requests for storage of the image information from image processing units belonging to the same group, and sequentially executes processing of the requests from the image processing units without performing exclusive access control; and
an exclusive access storage processing unit that receives requests for storage of the image information from image processing units belonging to different groups, and executes processing of the requests from the image processing units while performing exclusive access control.

2. The image processing apparatus according to claim 1, wherein the section number acquisition unit acquires as the number of sections a value equal to or less than the number of the computational units that can execute the computation related to image processing in parallel.

3. The image processing apparatus according to claim 1, wherein the section number acquisition unit acquires as the number of sections a value equal to or less than the number of the computational units having a usage rate of a predetermined value or less.

4. The image processing apparatus according to claim 1, wherein the sectioning unit sections the plurality of image processing units excluding an image processing unit, among the plurality of image processing units, that cannot execute processing unless image processing by another image processing unit ends.

5. The image processing apparatus according to claim 1, wherein the sectioning unit sections the plurality of image processing units such that the sum of processing amounts needed for the image processing units belonging to the same group to execute image processing is substantially equal between the respective groups.

6. The image processing apparatus according to claim 5, wherein the processing amount is predetermined for each unit of image processing executed by each of the image processing units, or is fixed by predetermined calculation.

7. The image processing apparatus according to claim 1, wherein the sequential storage processing unit and/or the exclusive access storage processing unit is connected at the preceding stage and/or at the following stage of one of the plurality of image processing units in a pipeline form or in a Directed Acyclic Graph form.

8. The image processing apparatus according to claim 1, wherein the image processing units belonging to the same group are connected to each other through the sequential storage processing unit in a pipeline form or in a Directed Acyclic Graph form.

9. The image processing apparatus according to claim 1, wherein the image processing units belonging to the different groups are connected to each other through the exclusive access storage processing unit in a pipeline form or in a Directed Acyclic Graph form.

10. The image processing apparatus according to claim 1, wherein the image processing that the plurality of image processing units cause the computational units to execute comprises at least one of input processing, filter processing, color conversion processing, scale-up/down processing, skew angle sensing processing, image rotation processing, image synthesis processing, or output processing.

11. A computer readable medium storing a program causing a computer to execute a process for image processing, the process comprising:
acquiring a number of sections for sectioning into a plurality of groups a plurality of image processing units that cause a plurality of computational units that execute computation relating to image processing to execute image processing on image information;
sectioning the plurality of image processing units by causing the respective image processing units to belong to the respective groups based on the acquired number of sections and based on the order of the image processing that the image processing units cause the computational units to execute;
receiving requests for storage of the image information from image processing units belonging to the same group, and sequentially executing processing of the requests from the image processing units without performing exclusive access control; and
receiving requests for storage of the image information from image processing units belonging to different groups, and executing processing of the requests from the image processing units while performing exclusive access control.

12. The computer readable medium according to claim 11, wherein the acquiring of the number of sections comprises acquiring as the number of sections a value equal to or less than the number of the computational units that can execute the computation related to image processing in parallel.

13. The computer readable medium according to claim 11, wherein the acquiring of the number of sections comprises acquiring as the number of sections a value equal to or less than the number of the computational units having a usage rate of a predetermined value or less.

14. The computer readable medium according to claim 11, wherein the sectioning comprises sectioning the plurality of image processing units excluding an image processing unit, among the plurality of image processing units, that cannot execute processing unless image processing by another image processing unit ends.

15. The computer readable medium according to claim 11, wherein the sectioning comprises sectioning the plurality of image processing units such that the sum of processing amounts needed for the image processing units belonging to the same group to execute image processing is substantially equal between the respective groups.

16. The computer readable medium according to claim 15, wherein the processing amount is predetermined for each unit of image processing executed by each of the image processing units, or is fixed by predetermined calculation.

17. An image processing method, comprising:
acquiring a number of sections for sectioning into a plurality of groups a plurality of image processing units that cause a plurality of computational units that execute computation relating to image processing to execute image processing on image information;
sectioning the plurality of image processing units by causing the respective image processing units to belong to the respective groups based on the acquired number of sections and based on the order of the image processing that the image processing units cause the computational units to execute;
receiving requests for storage of the image information from image processing units belonging to the same group, and sequentially executing processing of the requests from the image processing unit without performing exclusive access control; and
receiving requests for storage of the image information from image processing units belonging to different groups, and executing processing of the requests from the image processing units while performing exclusive access control.
